(19) United States
(12) Patent Application Publication
(10) Pub. No.: US 2023/0239704 A1
(43) Pub. Date: Jul. 27, 2023

(54) ELECTRONIC MANAGEMENT DEVICE AND METHOD FOR WIRELESS COMMUNICATION, AND COMPUTER-READABLE MEDIUM

(71) Applicant: Sony Group Corporation, Tokyo (JP)

(72) Inventor: Zhong TIAN, Beijing (CN)

(73) Assignee: Sony Group Corporation, Tokyo (JP)

(21) Appl. No.: 18/010,460

(22) PCT Filed: Jul. 23, 2021
(86) PCT No.: PCT/CN2021/108107

§ 371 Date: Dec. 15, 2022

(30) Foreign Application Priority Data
Jul. 31, 2020 (CN) 202010758670.5

(51) Int. Cl. H04W 16/14; H04W 72/0453

(52) U.S. Cl. CPC H04W 16/14; H04W 72/0453

(57) ABSTRACT

Provided are an electronic management device and method for wireless communication, and a computer-readable medium. The electronic management device comprises a processing circuit configured to: determine a first distribution attribute of an electronic spectrum acquisition device within a first region where the electronic management device is used as a reference point, and for spectrums to be traded within the scope of management of the electronic management device, determine a second distribution attribute of the electronic spectrum acquisition device within a second region where an electronic spectrum provision device for spectrums is used as a reference point, so as to manage spectrum trading on the basis of the first distribution attribute and the second distribution attribute.

### FIELD

The present disclosure relates to the technical field of wireless communications, in particular to processing related to spectrum trade, and more specifically, a management electronic device and a method for wireless communication, a spectrum providing electronic device and a method for wireless communication, a spectrum acquisition electronic device and a method for wireless communication, and a computer readable medium.

### BACKGROUND

5G, as a new infrastructure support technology vigorously promoted by the country, has three typical application scenarios: enhanced mobile broadband (eMBB), ultra-reliable low latency communication (uRLLC), and massive machine type of communication (mMTC). The basic features of 5G are: high speed, low latency, wide connectivity, ultra-dense heterogeneous network, software-defined network (SDN) and network function virtualization (NFV), as well as new network architecture.

To alleviate the scarcity of spectrum resources, fine-grained management of spectrum resources is allowed in 5G networks to share spectrum resources among bands, exchange spectrum resources between terminals, and dynamically share multiple networks (e.g., 5G network spectrum, Internet of things vertical industry spectrum, WIFI rights-free spectrum).

Usually, in 4G or 5G networks, a base station distributes different spectrum resource to different terminals. If some terminals do not communicate or do not utilize so many allocated spectrum resources for communication at certain times, a good idea is that these terminals may trade the idle spectrum resources to other terminals that desire spectrum resources urgently, so that the spectrum efficiency of this system is greatly improved.

### SUMMARY

A brief summary of the present invention is given below, to provide a basic understanding of some aspects of the present invention. It should be understood that the following summary is not an exhaustive summary of the present invention. It does not intend to determine a key or important part of the present invention, nor does it intend to limit the scope of the present invention. Its object is only to present some concepts in a simplified form, which serves as a preamble of a more detailed description to be discussed later.

According to one aspect of the present disclosure, there is provided a management electronic device for wireless communication. The management electronic device includes processing circuitry. The processing circuitry is configured to: determine a first distribution attribute of spectrum acquisition electronic devices in a first region taking the management electronic device as a reference point, and for a spectrum to be traded in a management range of the management electronic device, determine a second distribution attribute of spectrum acquisition electronic devices in a second region taking a spectrum providing electronic device of the spectrum as a reference point, so as to manage trade of the spectrum based on the first distribution attribute and the second distribution attribute.

According to one aspect of the present disclosure, there is provided a spectrum providing electronic device for wireless communication. The spectrum providing electronic device includes processing circuitry. The processing circuitry is configured to: determine, based on a first distribution attribute and a second distribution attribute determined by a management electronic device managing the spectrum providing electronic device, a selling price interval of a spectrum to be traded in spectrum trade related to the spectrum providing electronic device, for performing the spectrum trade. The first distribution attribute is a distribution attribute of spectrum acquisition electronic devices in a first region taking the management electronic device as a reference point, and the second distribution attribute is a distribution attribution of spectrum acquisition electronic devices in a second region taking the spectrum providing electronic device as a reference point.

According to one aspect of the present disclosure, there is provided a spectrum acquisition electronic device for wireless communication. The spectrum acquisition electronic device includes processing circuitry. The processing circuitry is configured to: determine, based on distribution attributions of spectrum acquisition electronic devices in a region taking a management electronic device as a reference point, an offer for a spectrum to be traded in spectrum trade related to the spectrum acquisition electronic device, for performing the spectrum trade. The management electronic device is an electronic device which manages the spectrum acquisition electronic device.

According to one aspect of the present disclosure, there is provided a method for wireless communication. The method includes: determining a first distribution attribute of spectrum acquisition electronic devices in a first region taking a management electronic device as a reference point, and for a spectrum to be traded in a management range of the management electronic device, determining a second distribution attribute of spectrum acquisition electronic devices in a second region taking a spectrum providing electronic device of the spectrum as a reference point, so as to manage trade of the spectrum based on the first distribution attribute and the second distribution attribute.

According to one aspect of the present disclosure, there is provided a method for wireless communication. The method includes: determining, based on a first distribution attribute and a second distribution attribute determined by a management electronic device managing a spectrum providing electronic device, a selling price interval of a spectrum to be traded in spectrum trade related to the spectrum providing electronic device, for performing the spectrum trade. The first distribution attribute is a distribution attribute of spectrum acquisition electronic devices in a first region taking the management electronic device as a reference point, and the second distribution attribute is a distribution attribution of spectrum acquisition electronic devices in a second region taking the spectrum providing electronic device as a reference point.

According to one aspect of the present disclosure, there is provided a method for wireless communication. The method includes: determining, based on distribution attributions of spectrum acquisition electronic devices in a region taking a management electronic device as a reference point, an offer for a spectrum to be traded in spectrum trade related to a spectrum acquisition electronic device, for performing the spectrum trade. The management electronic device is an electronic device which manages the spectrum acquisition electronic device.

According to other aspects of the present invention, there are further provided a computer program code and a computer program product for implementing the methods for wireless communication, as well as a computer readable storage medium on which the computer program code for implementing the methods for wireless communication is recorded.

These and other advantages of the present invention will be more apparent through the following detailed description of preferred embodiments of the present invention in conjunction with the accompanying drawings.

### BRIEF DESCRIPTION OF THE DRAWINGS

In order to further set forth the above and other advantages and features of the present invention, specific embodiments of the present invention will be further described in detail below in conjunction with the accompanying drawings. The accompanying drawings together with the following detailed description are included in this specification and form a part of this specification. Elements with identical functions and structures are denoted by identical reference numerals. It should be understood that, these drawings only illustrating typical examples of the present invention, and should not be regarded as limitations to the scope of the present invention. In the drawings:

FIG. 1 is a block diagram illustrating functional modules of a management electronic device for wireless communication according to an embodiment of the present disclosure;

FIG. 2 is a diagram illustrating a spectrum management system according to an embodiment of the present disclosure;

FIG. 3 is a schematic diagram illustrating determination of a set of spectrum providing electronic devices corresponding to a spectrum acquisition electronic device according to an embodiment of the present disclosure;

FIG. 4 is a diagram illustrating a structure of a block according to an embodiment of the present disclosure;

FIG. 5 is a schematic diagram illustrating information interaction related to spectrum trade according to an embodiment of the present disclosure;

FIG. 6 is a block diagram illustrating functional modules of a spectrum providing electronic device for wireless communication according to an embodiment of the present disclosure;

FIG. 7 is a schematic diagram illustrating determination of a second heat vector according to an embodiment of the present disclosure;

FIG. 8 is a schematic diagram illustrating a first plurality of concentric circles and a second plurality of concentric circles according to an embodiment of the present disclosure;

FIG. 9 is a block diagram illustrating functional modules of a spectrum acquisition electronic device for wireless communication according to an embodiment of the present disclosure;

FIG. 10 is a diagram illustrating an application scenario of a spectrum management system according to an embodiment of the present disclosure;

FIG. 11 is a flowchart illustrating a method for wireless communication according to an embodiment of the present disclosure;

FIG. 12 is a flowchart illustrating a method for wireless communication according to another embodiment of the present disclosure;

FIG. 13 is a flowchart illustrating a method for wireless communication according to another embodiment of the present disclosure;

FIG. 14 is a block diagram illustrating a first example of a schematic configuration of an eNB or gNB to which the technology of the present disclosure can be applied;

FIG. 15 is a block diagram illustrating a second example of a schematic configuration of an eNB or gNB to which the technology of the present disclosure can be applied;

FIG. 16 is a block diagram showing an example of a schematic configuration of a smartphone to which the technology of the present disclosure can be applied;

FIG. 17 is a block diagram showing an example of a schematic configuration of automobile navigation equipment to which the technology of the present disclosure can be applied; and

FIG. 18 is a block diagram of an exemplary structure of a universal personal computer in which the methods and/or apparatuses and/or systems according to the embodiments of the present invention can be implemented.

### DETAILED DESCRIPTION OF THE EMBODIMENTS

Hereinafter, exemplary embodiments of the present disclosure will be described in conjunction with the accompanying drawings. For the sake of clarity and conciseness, the description does not describe all features of actual embodiments. However, it should be understood that in developing any such actual embodiment, many decisions specific to the embodiments must be made, so as to achieve specific objects of a developer; for example, those limitation conditions related to systems and services are satisfied, and these limitation conditions possibly will vary as embodiments are different. In addition, it should also be appreciated that, although developing work may be very complicated and time-consuming, such developing work is only routine tasks for those skilled in the art benefiting from the present disclosure.

It should also be noted herein that, to avoid the present invention from being obscured due to unnecessary details, only those apparatus structures and/or processing steps closely related to the solution according to the present invention are shown in the accompanying drawings, while omitting other details not closely related to the present invention.

FIG. 1 is a block diagram illustrating functional modules of a management electronic device 100 for wireless communication according to an embodiment of the present disclosure. As shown in FIG. 1, the management electronic device 100 includes a first processing unit 101. The first processing unit 101 is configured to determine a first distribution attribute of spectrum acquisition electronic devices in a first region taking the management electronic device 100 as a reference point, and for a spectrum to be traded in a management range of the management electronic device 100, determine a second distribution attribute of spectrum acquisition electronic devices in a second region taking a spectrum providing electronic device providing the spectrum as a reference point, so as to manage trade of the spectrum based on the first distribution attribute and the second distribution attribute.

As an example, the spectrum acquisition electronic device is an electronic device for acquiring (e.g., purchasing) a spectrum. A spectrum providing electronic device is an electronic device for providing (e.g., selling) a spectrum. The management electronic device is an electronic device that manages the spectrum trade.

The first processing unit 101 may be implemented by one or more processing circuitries which may be implemented as, for example, a chip.

The management electronic device 100 may, for example, be arranged on a base station side or communicatively connected to a base station. For example, the management electronic device 100 may operate as the base station itself and may also include external devices such as a memory, a transceiver (not shown), etc. The memory may be configured to store programs to be executed by the base station to achieve various functions and related data information. The transceiver may include one or more communication interfaces to support communication with different devices (e.g., user equipment, and another base station), and the form of implementation of the transceiver is not specifically limited herein.

As an example, the management electronic device may be a base station. The spectrum acquisition electronic device and the spectrum providing electronic device each may be user equipment (UE) (hereinafter sometimes referred to as a terminal). However, the present disclosure is not limited thereto. For example, the management electronic device, the spectrum acquisition electronic device, and the spectrum providing electronic device may all be base stations.

Alternatively, for example, the spectrum acquisition electronic device and the spectrum providing electronic device each may be UE. The management electronic device may be UE capable of managing the spectrum trade.

In the case where the management electronic device is capable of managing the spectrum trade, the management electronic device 100 may, for example, be arranged on the user equipment side or communicatively connected to the user equipment. For example, the management electronic device 100 may operate as the user equipment itself and may also include external devices such as a memory, a transceiver (not shown in the drawings), etc. The memory may be configured to store programs to be executed by the user equipment to achieve various functions and related data information. The transceiver may include one or more communication interfaces to support communication with different devices (e.g., a base station, another user equipment, etc.), and the form of implementation of the transceiver is not specifically limited herein.

Other examples of the management electronic device, the spectrum acquisition electronic device, and the spectrum providing electronic device are also conceived by those skilled in the art and are not described in detail herein.

For example, the identities of the management electronic device, the spectrum acquisition electronic device, and the spectrum providing electronic device may be dynamically changing. For example, it is assumed that that at one point in time or for a period of time, an electronic device A serves as the management electronic device, an electronic device B serves as the spectrum acquisition electronic device, and an electronic device C serves as the spectrum providing electronic device. At another point in time or for another period of time, the electronic device A may serve as one of the management electronic device, the spectrum acquisition electronic device, the spectrum providing electronic device, and other electronic device other than the management electronic device, the spectrum acquisition electronic device, and the spectrum providing electronic device, the electronic device B may serve as one of the management electronic device, the spectrum acquisition electronic device, the spectrum providing electronic device, and other electronic device other than the management electronic device, the spectrum acquisition electronic device, and the spectrum providing electronic device, and the electronic device C may serve as one of the management electronic device, the spectrum acquisition electronic device, the spectrum providing electronic device, and other electronic device other than the management electronic device, the spectrum acquisition electronic device, and the spectrum providing electronic device.

For example, the spectrum provided by one spectrum providing electronic device may be the same or not the same as the spectrum provided by another spectrum providing electronic device. In a case that different spectrum providing electronic devices provide the same spectrum, the spectrum acquisition electronic device may trade spectrum with at least one of the different spectrum providing electronic devices.

In the following, the management electronic device is a base station, the spectrum acquisition electronic device and the spectrum providing electronic device each is UE are described as examples.

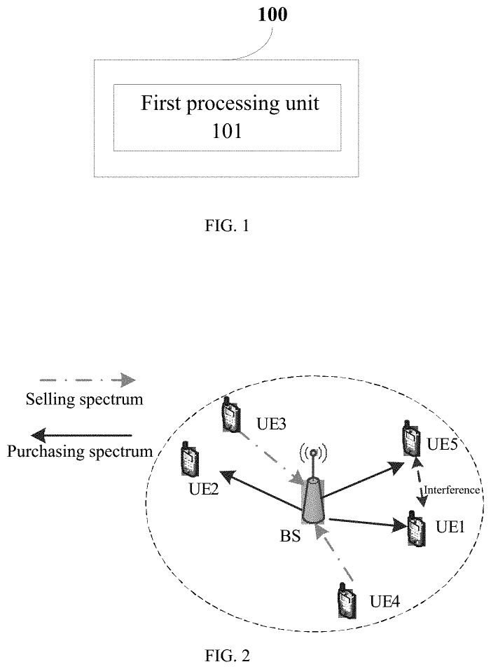

FIG. 2 is a diagram illustrating a spectrum management system according to an embodiment of the present disclosure. In FIG. 2, a base station BS serves as the management electronic device, user equipment UE1, UE2, and UE5 each serve as the spectrum acquisition electronic device, and user equipment UE3 and UE4 each serve as the spectrum providing electronic device. As shown in FIG. 2, user equipment UE1 to UE5 communicate with the base station BS. UE3 and UE4 have no demand for communication or the communication utilizes very little spectrum resources in some time, and may provide the idle spectrum resources for trading. It is assumed that UE1, UE2 and UE5 have higher communication rate requirements and desire more spectrum resources and desire to obtain the required spectrum resources from the spectrum providing electronic devices. In FIG. 2, a one-way arrow with a dashed line indicates spectrum providing (i.e., selling spectrum) and a one-way arrow with a solid line indicates spectrum acquisition (i.e., purchasing spectrum). As shown in FIG. 2, two spectrum acquisition electronic devices, in close proximity (e.g., UE1 and UE5), may interfere with each other due to the purchased spectrum resources. It should be noted that during the spectrum trade, one spectrum acquisition electronic device is allowed to quote to multiple spectrum providing electronic devices, and the buyer and seller of spectrum trade may not reach a deal due to the price, or may not complete the deal due to the interference.

The first region with the management electronic device 100 as the reference point may be any shaped region with the management electronic device 100 as the reference point, e.g., any shaped region (e.g., a circular region or a rectangular region) centered on the management electronic device 100.

The second region with the spectrum providing electronic device as the reference point may be any shaped region with the spectrum providing electronic device as the reference point, for example, any shaped region (e.g., a circular region or a rectangular region) centered on the spectrum-providing electronic device.

For example, those skilled in the art may determine the sizes of the first region and the second region based on practical needs, experience, or experimentation, etc.

For example, multiple spectrums to be traded exists within the management range of the management electronic device 100. The management electronic device 100 may determine a first distribution attribute of the spectrum acquisition electronic devices, within the first region, corresponding to the multiple spectrums to be traded (i.e., a distribution attribute of all spectrum acquisition electronic devices within the first region), and a second distribution attribute of the spectrum acquisition electronic devices, within the second region, corresponding to the multiple spectrums to be traded (i.e., a distribution attribute of all spectrum acquisition electronic devices within the second region). For at least one spectrum to be traded among the multiple spectrums to be traded, the management electronic device 100 may manage the trade of the at least one spectrum based on the first distribution attribute and the second distribution attribute.

The existing management electronic device fails to consider the distribution attribute of the spectrum acquisition electronic device when managing the spectrum trade. However, it is known from the above description that the management electronic device 100 according to embodiments of the present disclosure efficiently manages spectrum trade in the system based on the first distribution attribute and the second distribution attribute, thereby improving the spectrum efficiency of the system.

For example, the first distribution attribute is characterized by a first heat vector. The first heat vector indicates numbers of the spectrum acquisition electronic devices respectively included in a first plurality of concentric circles of which a center is the management electronic device 100, in the first region. The second distribution attribute is characterized by a second heat vector. The second heat vector indicates numbers of the spectrum acquisition electronic devices respectively included in a second plurality of concentric circles of which a center is the spectrum providing electronic device, in the second region. The first heat vector is for measuring global density of the spectrum acquisition electronic devices around the management electronic device 100 within each of the first plurality of concentric circles. The second heat vector is for measuring global density of the spectrum acquisition electronic devices around the spectrum providing electronic device within each of the second plurality of concentric circles. For a description of the first heat vector and the second heat vector, reference is made to the embodiments of the spectrum providing electronic device 600 and the spectrum acquisition electronic device 700 to be described below.

For example, the first distribution attribute is characterized by a first quadrant vector. The first quadrant vector indicates numbers of the spectrum acquisition electronic devices respectively included in four quadrants of each of a third plurality of concentric circles of which a center is the management electronic device 100, in the first region. The second distribution attribute is characterized by a second quadrant vector. The second quadrant vector indicates numbers of the spectrum acquisition electronic devices respectively included in four quadrants of a circle of which a center is the spectrum providing electronic device, in the second region. The first quadrant vector is for measuring partition density of the spectrum acquisition electronic devices around the management electronic device 100 in different quadrants. The second quadrant vector is for measuring partition density of the spectrum acquisition electronic devices around the spectrum providing electronic device in different quadrants. For a description of the first quadrant vector and the second quadrant vector, reference is made to the embodiments of the spectrum providing electronic device 600 and the spectrum acquisition electronic device 700 to be described below.

For example, the first processing unit 101 may be configured to match a selling price interval for the spectrum provided by the spectrum providing electronic device with an offer for the spectrum provided by the spectrum acquisition electronic device which is to acquire the spectrum. The spectrum providing electronic device provides the selling price interval based on the first distribution attribute and the second distribution attribute, and the spectrum acquisition electronic device which is to acquire the spectrum provides the offer based on the first distribution attribute. For a description of the spectrum providing electronic device providing the selling price interval based on the first distribution attribute and the second distribution attribute and the spectrum acquisition electronic device which is to acquire the spectrum providing the offer based on the first distribution attribute, reference is made to the embodiments of the spectrum providing electronic device 600 and the spectrum acquisition electronic device 700 to be described below.

It is assumed that for a frequency of unit bandwidth W, all the user equipment and the base stations have a publicly known predetermined price list with a minimum price of Yₘᵢₙ and a maximum price of Yₘₐₓ. It is assumed that the number of intervals in the price list is M (which is a positive integer greater than or equal to 1). The price bands in the price list may be equidistant or may be not equidistant (i.e., these intervals may be equal or unequal in size). For ease of description, the following assumes that the price bands in the price list are equidistant, the all price bands be expressed as: Yₖ=Yₘᵢₙ+k(Yₘₐₓ−Yₘᵢₙ)/M, where k=0, . . . , M. A (j+1)^{th} selling price interval may be expressed as [Yⱼ,Yⱼ₊₁], where j=0, 1, . . . , M−1. Yⱼ is the lower limit of the (j+1)^{th} selling price interval, Yⱼ₊₁ is the upper limit of the (j+1)^{th} selling price interval, Y₀=Yₘᵢₙ, and Y_{M}=Yₘₐₓ.

The management electronic device 100 according to embodiments of the present disclosure may match the selling price interval and the offer price, i.e., persuade the spectrum providing electronic device and the spectrum acquisition electronic device that is to acquire the spectrum, so as to facilitate trade for the spectrum.

For example, the first processing unit 101 may be configured to determine the selling price of the spectrum by one of: if there is one or more spectrum acquisition electronic devices, among the spectrum acquisition electronic devices to acquire the spectrum, whose offer is within the selling price interval, selecting a highest offer from the offers of the one or more spectrum acquisition electronic devices, as the selling price of the spectrum; if there is no spectrum acquisition electronic device, among the spectrum acquisition electronic devices to acquire the spectrum, whose offer is within the selling price interval, selecting a lowest offer, from the offers of the spectrum acquisition electronic devices to acquire the spectrum, that is greater the upper limit of the selling price interval, as the selling price of the spectrum; and if offers of the spectrum acquisition electronic devices to acquire the spectrum are all smaller than the lower limit of the selling price interval, selecting a highest offer from the offers of the spectrum acquisition electronic devices to acquire the spectrum, calculating an average of the selected highest offer and the lower limit of the selling price interval, and selecting one of the selected highest offer, the average, and the lower limit of the selling price interval as the selling price of the spectrum.

For example, the spectrum providing electronic device provides a selling price interval [Yⱼ, Yⱼ₊₁] (j=0, 1, . . . , M−1) and receives offers from multiple spectrum acquisition electronic devices.

If there are offers from the spectrum acquisition electronic devices are within the interval [Yⱼ, Yⱼ₊₁], the highest offer among these offers is selected as the selling price. The spectrum acquisition electronic device providing the selected highest offer becomes the spectrum acquisition electronic device in this spectrum trade.

In the case where all the spectrum acquisition electronic devices provide offers that are not within the interval [Yⱼ, Yⱼ₊₁], the management electronic device 100 first selects the lowest offer which is higher than Yⱼ₊₁ among the offers. In a case of successful selection, the management electronic device 100 determines the selected offer as the selling price. The spectrum acquisition electronic device providing the selected offer becomes the spectrum acquisition electronic device in this spectrum trade.

In the case where all the spectrum acquisition electronic devices provide offers less than Yⱼ, the management electronic device 100 selects the highest offer yₗₘ among the offers from all of the spectrum acquisition electronic devices. The management electronic device 100 calculates an average of the highest offer yₗₘ and the lower limit Yⱼ of the selling price interval as (yₗₘ+Yⱼ)/2. For example, the management electronic device 100 may feed the three prices yₗₘ, Yⱼ, and (yₗₘ+Yⱼ)/2 to the spectrum providing electronic device and the spectrum acquisition electronic device, so that the spectrum providing electronic device and the spectrum acquisition electronic device achieve a selection among the three prices (multiple selections are allowed). The spectrum providing electronic device and the spectrum acquisition electronic device send the results of selection back to the management electronic device 100, which checks whether there is a common selection of the three prices by the spectrum providing electronic device and the spectrum acquisition electronic device. If there are multiple common selections of price for the spectrum providing electronic device and the spectrum acquisition electronic device, the management electronic device 100 selects the price in favor of the spectrum providing electronic device as the final price. For example, the management electronic device 100 may select the highest price of the multiple common prices as the final price.

For example, the first processing unit 101 may be configured to determine, based on at least one of a first condition and a second condition, a set of spectrum providing electronic devices corresponding to a spectrum acquisition electronic device within the management range of the management electronic device 100. The first condition includes that the spectrum acquisition electronic device and the spectrum providing electronic device involved in the trade of the spectrum are located in the same sector of the management electronic device 100. The second condition includes that the spectrum providing electronic device is located within a predetermined region centered on the spectrum acquisition electronic device.

The set of spectrum providing electronic devices corresponding to the spectrum acquisition electronic device includes all spectrum providing electronic devices that may trade with the spectrum acquisition electronic device with respect to the spectrum to be acquired by the spectrum acquisition electronic device.

After the spectrum providing electronic device trades spectrum to the spectrum acquisition electronic device, the transfer of the access to the spectrum resource results in a reshaping of the interference relationship between base station and respective user equipment in the entire spectrum management system. By regulating the spectrum acquisition electronic device and the spectrum providing electronic device that achieve the trade, the change of the interference relationship due to the transfer of the access to the spectrum resource can be effectively reduced.

The first condition requires that the spectrum acquisition electronic device and the spectrum providing electronic device that achieve the trade should be located in the same sector of the management electronic device 100 (e.g., the base station). In this way, when the base station uses beamforming techniques, the trade of spectrum resource occurs only within the sector and thus results in no effect on user equipment outside the sector.

The sector may be regulated based on two parameters a₁ and a₂. a₁ and a₂ are radians corresponding to starting and ending edges of the sector, respectively, ranging from 0 to 2π. The specific determination of a₁ and a₂ is related to the division of spectrum resources by the base station at the beginning. It is assumed that the base station divides the circular region within the coverage region into multiple sectors, and the same spectrum resources may be allocated to sectors that are not adjacent, so that utilization of the spectrum resources can be maximized.

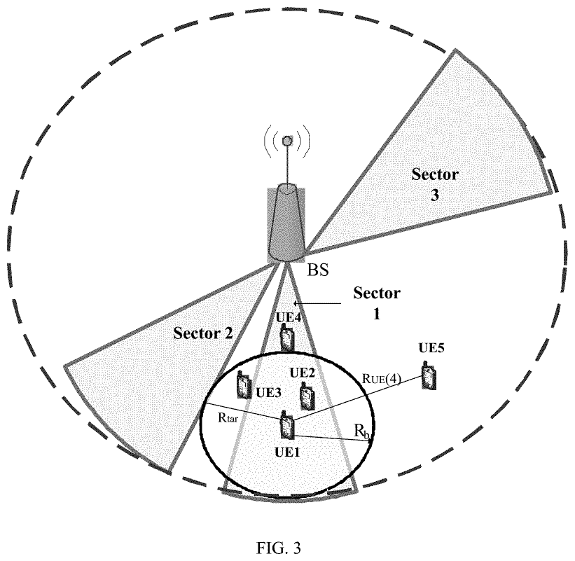

FIG. 3 is a schematic diagram illustrating determination of the set of spectrum providing electronic devices corresponding to the spectrum acquisition electronic device according to an embodiment of the present disclosure. In FIG. 3, sectors 1 to 3 of the base station BS is schematically illustrated. The sector 1 and the sector 2 are assigned the same spectrum resources. It is assumed that UE1 is a spectrum acquisition electronic device, located in the sector 1, and UE2 to UE5 each are a spectrum providing electronic device. The first condition limits the set of spectrum providing electronic devices corresponding to the UE1 to the sector 1 (e.g., the set of spectrum providing electronic devices corresponding to the UE1 includes the UE2 and the UE4 located within the sector 1), so that interference between electronic devices due to the UE1 trading with the spectrum providing electronic device within the sector 2 can be avoided.

The second condition provides that the spectrum providing electronic device with which the spectrum acquisition electronic device trades is located within a predetermined region centered on the spectrum acquisition electronic device. For example, the predetermined region may be an region of any shape centered on the spectrum acquisition electronic device. For simplicity, the predetermined region is described as an example where the predetermined region is a circular region centered on the spectrum acquisition electronic device.

For example, the first processing unit 101 may be configured to calculate, in the case where the predetermined region is a circle, a first calculation radius corresponding to the case where the circle includes a predetermined number of spectrum providing electronic devices, and a second calculation radius of an outer tangent circle of the spectrum acquisition electronic device to another co-frequency sector that is different from the sector in which the spectrum acquisition electronic device is located. A radius of the circle is less than or equal to both the first calculation radius and the second calculation radius.

The second condition provides that spectrum providing electronic devices of at most a predetermined number N (which is a positive integer greater than or equal to 1) are included within a circular region centered on the spectrum acquisition electronic device. The first calculation radius may be expressed as R_{UE}(N) (which is a minimum radius of the circular region centered on the spectrum acquisition electronic device including N spectrum providing electronic devices). The first calculation radius R_{UE}(4) calculated in a case of N=4 is shown in FIG. 3 (which is a minimum radius of a circular region centered on the spectrum acquisition electronic device including four spectrum providing electronic devices, for example, UE2 to UE5). In addition, the second condition also provides that the circular region centered on the spectrum acquisition electronic device cannot cover two sector regions of the same frequency in the section division regions centered on the base station. If Rₜₐᵣ denotes a radius of an outer tangent circle from the UE1 to the same frequency sector (sector 2) as the sector 1 in FIG. 3, the radius R_{b} of the circular region centered on the spectrum acquisition electronic device is less than min{R_{UE}(N), Rₜₐᵣ}. min{R_{UE}(N), Rₜₐᵣ} indicates a smaller one between R_{UE}(N) and Rₜₐᵣ. It is assumed that Rₜₐᵣ is less than R_{UE}(N), and therefore R_{b} is less than or equal to Rₜₐᵣ. As shown in FIG. 3, it may be determined based on the circular region with the radius R_{b} that the set of spectrum providing electronic devices corresponding to the UE1 including UE2 and UE3.

With the second condition, spectrum trade occurs only locally. The transfer of spectrum resources before and after spectrum trade does not affect the whole coverage of the base station.

For example, the set of spectrum providing electronic devices corresponding to the spectrum acquisition electronic device may always be determined based on the first condition, or always be determined based on the second condition, or sometimes be determined based on the first condition and sometimes based on the second condition. The set of spectrum providing electronic devices determined based on the first condition is determined as the final set of spectrum providing electronic devices corresponding to the spectrum acquisition electronic devices. Alternatively, the set of spectrum providing electronic devices determined based on the second condition is determined as the final set of spectrum providing electronic devices corresponding to the spectrum acquisition electronic devices. Alternatively, an intersection of the set of spectrum providing electronic devices determined based on the first condition and the set of spectrum providing electronic devices determined based on the second condition is determined as the final set of spectrum providing electronic devices corresponding to the spectrum acquisition electronic device.

For example, the management electronic device 100 may calculate a range of spectrum providing electronic devices based on a minimum data transmission rate requirement of the spectrum acquisition electronic device and determine the set of spectrum providing electronic devices corresponding to the spectrum acquisition electronic device within the range.

As can be seen from the above description, determining the set of spectrum providing electronic devices corresponding to the spectrum acquisition electronic device can reduce neighboring or co-frequency interference resulted from the transfer of usage of the spectrum resource.

For example, the management electronic device 100 may be a main subject in a spectrum management system configured as a blockchain architecture. The spectrum management system includes multiple main subjects. In addition to the management electronic device, the multiple main subjects include at least one of a spectrum acquisition electronic device, a spectrum providing electronic device, and other electronic devices. The multiple main objects hold identical copies of a database. The copies of the database respectively held by the plurality of subjects are updated based on information about spectrum trade which is verified as valid.

According to embodiments of the present disclosure, a combination of blockchain and spectrum trade is provided. The blockchain can effectively record the trade and serve as a carrier for information interaction of various electronic devices regarding the spectrum trade, so as to ensure the security and reliability of spectrum trade. Taking 5G communication as an example, a typical scenario in which the blockchain is applied to 5G communication is dynamic spectrum management and sharing. For example, the blockchain may help 5G to solve the problems of user privacy and information security, trust establishment for online trade, and virtual intellectual property protection. In addition, the blockchain, as a distributed ledger technology, may be utilized to manage the problem of shared allocation and use of multiple spectrums by multiple networks and multiple terminals. The present disclosure is not limited to combining blockchain with the 5G communication. The above description of combination of the blockchain with 5G communication is also applicable to combination of the blockchain with other communication systems other than the 5G communication (e.g., 4G communication).

In a configuration combined with blockchain, each electronic device may have a certain number of initial spectrum coins, which are given by the base station. The spectrum trade is done in the form of spectrum coins and involves the transfer of spectrum coins.

The management electronic device 100 (e.g., a base station) may summarize pending trades and send them to various subjects in a block chain. For example, the base station includes attribute information in the block for each pending trade.

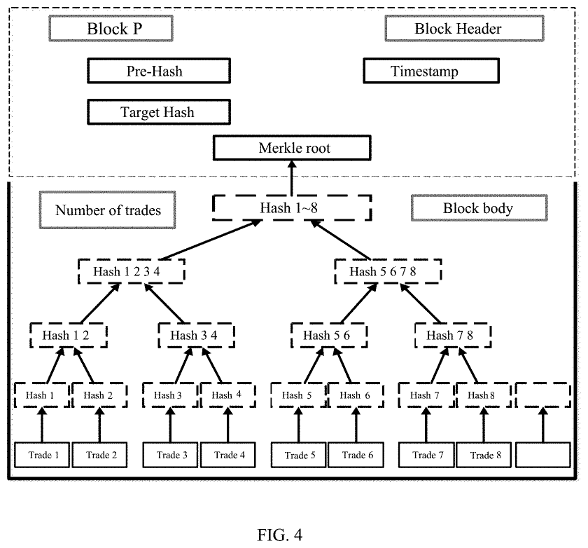

FIG. 4 illustrates an example of the structure of a block according to an embodiment of the present disclosure. In FIG. 4, a block P is described as an example. As shown in FIG. 4, the block includes a block header and a block body. Although not all are shown in FIG. 4, the block header may encapsulate information such as the current version number, the hash of the previous block (pre-Hash), the target hash of the current block (target Hash), the Merkle root, and a timestamp. The block body includes data about the trade (e.g., the number of trades) in the block P. For example, the data of the trade to be verified in the block body are grouped. As shown in FIG. 4, the hash values Hash 1 to Hash 8 of the trade 1 to the trade 8 are grouped. The generated new hash values Hash 1 2, Hash 3 4, Hash 5 6, and Hash 7 8 are inserted into a Merkle tree, and then Hash 1 2 3 4 and Hash 5 6 7 8 are generated recursively and so on, until the last root hash value Hash 1˜8 is generated. The Hash 1˜8 is noted as the Merkle root of the block header. Finally, the Merkle root is encapsulated into the block header. Since any change in the trade data may result in a change in the Merkle root, the existence and integrity of the block data can be quickly summarized and verified.

In the case where the subject is the spectrum acquisition electronic device or the spectrum providing electronic device of the trade, the subject verifies the information of the buyer and seller of this trade, for example, verifying the bandwidth of the spectrum resource of the trade, the price and other information. If there are no errors in this information, the trade is agreed. In a case that the subject is an electronic device that is not be affected by interference after this trade, the subject does not verify this transaction, and therefore not be rewarded with spectrum coins.

In the case where the subject is an electronic device that may be affected by interference after this trade, the subject verifies this transaction. For example, the other electronic device in the spectrum management system verifies the validity of the spectrum trade in the case where it is determined that the other electronic device is located in the validation region of the spectrum transaction. A signal-to-noise ratio of the other electronic device is determined based on the interference to the other electronic device when the spectrum acquisition electronic device in the spectrum trade utilizing the traded spectrum. In the case where the signal-to-noise ratio is greater than a predetermined signal-to-noise ratio threshold set for the other electronic device, the other electronic device verifies that the spectrum trade is valid.

The spectrum trade may result in a transfer of the access to the spectrum. By verifying the spectrum trade, harmful interference caused by the spectrum trade to other electronic devices on the same or adjacent channels as the spectrum being traded is reduced.

The validation region may be any shaped region with the spectrum acquisition electronic device in the spectrum trade as a reference point. For example, the validation region may be a circular region centered on the spectrum acquisition electronic device in the spectrum trade. For example, those skilled in the art may determine a size of the radius of the circular region based on practical needs, experience, or experimentation, etc.

For example, the other electronic device may determine whether it is located within the validation region of the spectrum trade based on a distance d_{inf} from the spectrum acquisition electronic device in the spectrum trade.

The other electronic device may calculate, from the following expression (1), the interference to the other electronic device when the spectrum acquisition electronic device in the spectrum trade performs communication with the spectrum obtained by the trade.

$${I}_{1}^{b} = {P}_{Tx} \cdot {G}_{Tx} \cdot {( \frac{λ}{4 π {d}_{inf}^{2}} )}^{α} \qquad ( 1 )$$

In expression (1), d_{inf} represents a distance of other electronic devices from the spectrum acquisition electronic device in the spectrum trade, P_{Tx} and G_{Tx} represent a transmit power and a transmit gain of the acquisition electronic device in the spectrum trade, respectively, α represents a path loss factor, and X represents a wavelength of the traded spectrum.

The other electronic device then calculates, from the following expression (2), the signal-to-noise ratio of the other electronic device when the spectrum acquisition electronic device in the spectrum trade performs communication with the spectrum obtained from the

$$SIN {R}_{1}^{b} = \frac{{P}_{Rx}}{{I}_{1}^{b} + {N}_{0}} \qquad ( 2 )$$

In expression (2), P_{Rx} denotes a received power of the other electronic device, and N₀ is the noise power.

Assuming that the predetermined signal-to-noise ratio threshold set for the other electronic device is denoted as SINRₜₕ, the other electronic device verifies that the spectrum trade is valid if the signal-to-noise ratio SINR₁^{b} is greater than the predetermined signal-to-noise ratio threshold SINRₜₕ. If SINR₁^{b} is less than or equal to the predetermined signal-to-noise ratio threshold SINRₜₕ, the trade may affect normal communication of the other electronic device, and thus the other electronic device may disagree with the trade.

The other electronic device, only when being located in the validation region, validates the spectrum trade, so that the system overhead for validating the spectrum trade and the number of electronic devices that validate the spectrum trade are reduced, thereby improving validation efficiency. In addition, the other electronic device validates the spectrum trade as valid only when the signal-to-noise ratio of the other electronic device when the spectrum acquisition electronic device performs communication with the traded spectrum is greater than the predetermined signal-to-noise ratio threshold. Therefore, the interference of spectrum trade to other electronic device is effectively reduced, thereby significantly improving the system performance (e.g., improving the signal-to-noise ratio of the electronic device).

For example, the other electronic device is rewarded with a certain number of spectrum coins for participating in the validation of each trade.

The management electronic device 100 (e.g., the base station) determines whether the trade is legitimate or illegitimate by voting after collecting verification information from the electronic devices for the trade in the block. The spectrum providing electronic device and the spectrum acquisition electronic device have one vote against this trade. The other electronic device related to this trade (i.e., an electronic device that may be affected by interference after this trade, i.e., the other electronic device validates this trade) determines whether the trade is legitimate or illegitimate based on majority-minority vote. The management electronic device 100 writes the legitimate trade into a new block and distributes the block to the electronic devices.

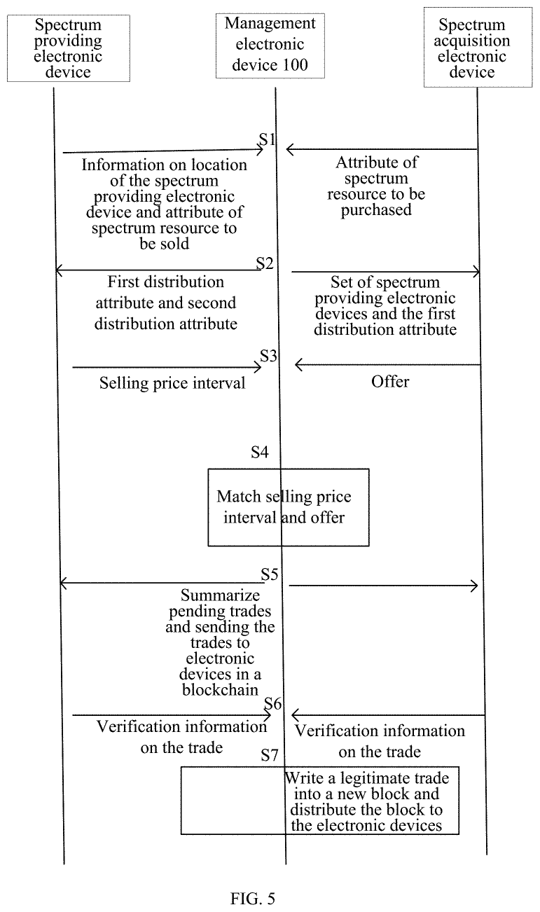

FIG. 5 is a diagram illustrating information interaction related to the spectrum trade according to the embodiment of the present disclosure. In FIG. 5, description is made in conjunction with a blockchain.

In S1, the spectrum providing electronic device reports to the management electronic device 100 attributes of the spectrum resource to be sold (e.g., a bandwidth and a center frequency point of the spectrum to be sold) and location information of the spectrum providing electronic device. The spectrum acquisition electronic device reports to the management electronic device 100 attributes of the spectrum resource to be purchased (e.g., a bandwidth and a center frequency point of the spectrum to be purchased).

In S2, the management electronic device 100 determines the set of spectrum providing electronic devices corresponding to the spectrum acquisition electronic device, and the first distribution attribute and the second distribution attribute; and informs the spectrum acquisition electronic device of the set of spectrum providing electronic devices and the first distribution attribute, and informs the spectrum providing electronic device of the first distribution attribute and the second distribution attribute.

In S3, the spectrum providing electronic device provides a selling price interval for the spectrum to be sold based on the first distribution attribute and the second distribution attribute obtained from the management electronic device 100. The spectrum acquisition electronic device provides an offer for the spectrum based on the first distribution attribute.

In S4, the management electronic device 100 matches the selling price interval for the spectrum given by the spectrum providing electronic device with the offer for the spectrum given by the spectrum acquisition electronic device, so as to facilitate spectrum trade.

In S5, the management electronic device 100 summarizes the trade to be performed and sends the trade to be performed to all electronic devices in the blockchain. In the case where the electronic device is the spectrum acquisition electronic device or spectrum providing electronic device for the trade, and where the electronic device is an electronic device that may be affected due to interference after this trade, the electronic device validates this trade.

In S6, the subject validating the trade reports validation information for the trade to the management electronic device 100.

In S7, the management electronic device 100 writes the legitimate trade to a new block and distributes the block to the electronic devices.

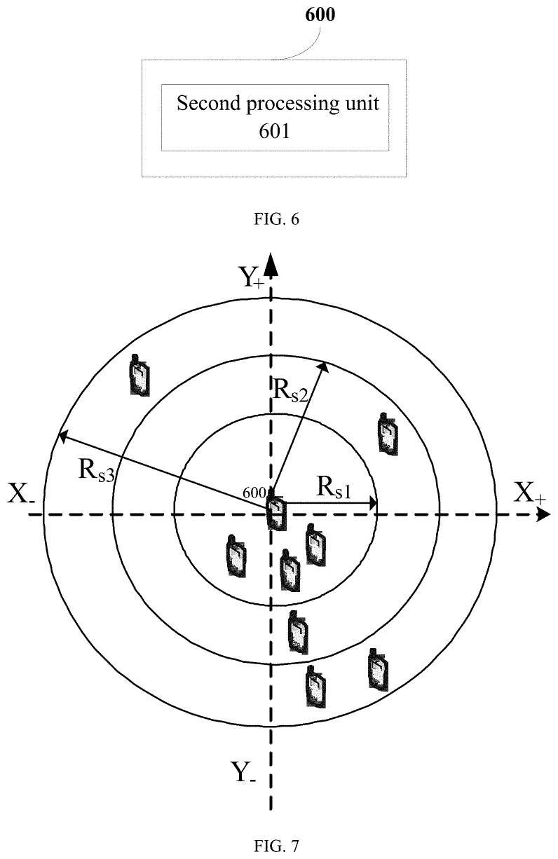

According to another embodiment of the present disclosure, there is also provided a spectrum providing electronic device 600 for wireless communication. FIG. 6 is a block diagram illustrating functional modules of the spectrum providing electronic device 600 for wireless communication according to an embodiment of the present disclosure. As shown in FIG. 6, the spectrum providing electronic device 600 includes a second processing unit 601. The second processing unit 601 is configured to determine, based on a first distribution attribute and a second distribution attribute determined by a management electronic device managing the spectrum providing electronic device 600, a selling price interval of a spectrum to be traded in spectrum trade related to the spectrum providing electronic device, for performing the spectrum trade. The first distribution attribute is a distribution attribute of spectrum acquisition electronic devices in a first region taking the management electronic device as a reference point, and the second distribution attribute is a distribution attribution of spectrum acquisition electronic devices in a second region taking the spectrum providing electronic device 600 as a reference point.

The second processing unit 601 may be implemented by one or more processing circuitries which may be implemented as, for example, a chip.

The spectrum providing electronic device 600 may, for example, be arranged on the user equipment side or communicatively connected to the user equipment. For example, the spectrum providing electronic device 600 may operate as the user equipment itself and may also include external devices such as a memory, a transceiver (not shown in the drawings), etc. The memory may be configured to store programs to be executed by the user equipment to implement various functions and related data information. The transceiver may include one or more communication interfaces to support communication with different devices (e.g., a base station, and another user equipment), and the form of implementation of the transceiver is not specifically limited herein.

The spectrum providing electronic device 600 may, for example, be arranged on a base station side or communicatively connected to a base station. For example, the spectrum providing electronic device 600 may operate as the base station itself and may also include external devices such as a memory, a transceiver (not shown), etc. The memory may be configured to store programs to be executed by the base station to achieve various functions and related data information. The transceiver may include one or more communication interfaces to support communication with different devices (e.g., user equipment, another base station, etc.), and the form of implementation of the transceiver is not specifically limited herein.

Examples of the management electronic device, the spectrum providing electronic device 600, and the spectrum acquisition electronic device has described in the embodiments of the management electronic device 100 above and thus are not repeated here. In the following, the description is made with the management electronic device being a base station, and the spectrum acquisition electronic device and the spectrum providing electronic device 600 each being UE.

The first region with the management electronic device as a reference point may be any shaped region with the management electronic device as a reference point, for example, any shaped region (e.g., a circular region or a rectangular region) centered on the management electronic device.

The second region with the spectrum providing electronic device 600 as the reference point may be any shaped region with the spectrum providing electronic device 600 as the reference point, for example, any shaped region (e.g., a circular region or a rectangular region) centered on the spectrum providing electronic device 600.

For example, those skilled in the art may determine the sizes of the first region and the second region based on practical needs, experience, or experimentation, etc.

For example, multiple spectrums to be traded exist within the management range of the management electronic device. The management electronic device may determine a first distribution attribute of the spectrum acquisition electronic devices, within the first region, corresponding to the multiple spectrums to be traded, and a second distribution attribute of the spectrum acquisition electronic devices, within the second region, corresponding to the multiple spectrums to be traded.

The existing spectrum providing electronic devices fails to consider the distribution attributes of the spectrum acquisition electronic device when determining the selling price of the spectrum. However, the spectrum providing electronic device 600 according to embodiments of the present disclosure provides a reasonable selling price interval of the spectrum to be traded based on the first distribution attribute and the second distribution attribute, so as to facilitate the spectrum trade, thereby improving the spectrum efficiency of the system.

For example, the first distribution attribute is characterized by a first heat vector. The first heat vector indicates numbers of the spectrum acquisition electronic devices respectively included in a first plurality of concentric circles of which a center is the management electronic device, in the first region. The second distribution attribute is characterized by a second heat vector. The second heat vector indicates numbers of the spectrum acquisition electronic devices respectively included in a second plurality of concentric circles of which a center is the spectrum providing electronic device 600, in the second region. The first heat vector is for measuring global density of the spectrum acquisition electronic devices around the management electronic device within each of the first plurality of concentric circles. The second heat vector is for measuring global density of the spectrum acquisition electronic devices around the spectrum providing electronic device 600 within each of the second plurality of concentric circles.

It is assumed that radii of the first plurality of concentric circles centered on the management electronic device (e.g., a base station) are R_{bs1}, R_{bs2}, . . . , R_{bsQ} (where Q is a positive integer greater than or equal to 1) sequentially, and the numbers of spectrum acquisition electronic devices in the concentric circles are (N_{bs1}, N_{bs2}, . . . , N_{bsQ}) sequentially. Then, the first heat vector may be expressed as (R_{bs1}, N_{bs1}, R_{bs2}, N_{bs2}, . . . , R_{bsQ}, N_{bsQ}).

It is assumed that radii of the second plurality of concentric circles centered on the spectrum providing electronic device 600 are Rₛ₁, Rₛ₂, . . . , R_{sT} (where T is a positive integer greater than or equal to 1) sequentially, and the numbers of spectrum axquisition electronic devices in the concentric circles are (N₁, N₂, . . . , N_{T}) sequentially. Then, the second heat vector may be expressed as (Rₛ₁, N₁, Rₛ₂, N₂, . . . , R_{sT}, N_{T}).

FIG. 7 is a schematic diagram illustrating determination of the second heat vector according to an embodiment of the present disclosure. Three concentric circles with radii Rₛ₁, Rₛ₂, and Rₛ₃, respectively, centered on the spectrum providing electronic device 600 are illustrated in FIG. 7. X+ and X− denote the positive and negative directions of the X-axis, respectively. Y+ and Y− denote the positive and negative directions of the Y-axis, respectively. In FIG. 7, a total of 9 user equipment is illustrated, each of which is a cell phone as an example. Except for the spectrum providing electronic device 600, all of other among the 9 user equipment is a spectrum acquisition electronic device. As shown in FIG. 7, the numbers of spectrum acquisition electronic devices included in the three concentric circles with radii Rₛ₁, Rₛ₂, and Rₛ₃ are 3, 5, and 8, respectively. Therefore, the second heat vector is expressed as (Rₛ₁, 3, Rₛ₂, 5, Rₛ₃, 8).

For example, the second processing unit 601 may be configured to: in the case of determining that the spectrum providing electronic device 600 is located between a first concentric circle having a first radius among the first plurality of concentric circles and a second concentric circle having a second radius greater than the first radius, calculate, based on the first radius and a first number of spectrum acquisition electronic devices corresponding to the first radius in the first heat vector, and the second radius and a second number of spectrum acquisition electronic devices corresponding to the second radius in the first heat vector, an anchor heat factor H₀ indicating a distribution density of spectrum acquisition electronic devices at a location within the first region where the spectrum providing electronic device 600 is located; calculate, based on the radius corresponding to each of the second plurality of concentric circles and the numbers of spectrum acquisition electronic devices corresponding to the radius respectively in the second heat vector, a current heat factor Hₒₜ indicating a distribution density of the spectrum acquisition electronic devices at a location within the second region in which the spectrum providing electronic device 600 is located; determine a selling price Y_{obj} corresponding to the current heat factor based on the highest price Yₘₐₓ and the lowest price Yₘᵢₙ in the predetermined price list and the anchor heat factor; and determine an interval in which the selling price falls within the range of the lowest price Yₘᵢₙ to the highest price Yₘₐₓ is the selling price interval.

The spectrum providing electronic device 600 can obtain information about the distribution of the spectrum acquisition electronic device based on the first heat vector and the second heat vector, and therefore can determine a more reasonable selling price interval.

For example, assuming that a distance between the spectrum providing electronic device 600 and the management electronic device is dx, where R_{bsi}<dₓ<R_{bs(i+1)}, and R_{bsi} and R_{bs(i+1)} are radii of two adjacent concentric circles among concentric circles of radii R_{bs1}, R_{bs2}, . . . , R_{bsQ} centered on the management electronic device, where 1≤i≤Q−1. The second processing unit 601 may determine, based on the distance dx, that the spectrum providing electronic device 600 is located between a first concentric circle having a first radius R_{bsi} and a second concentric circle having a second radius R_{bs(i+1)} among the first plurality of concentric circles.

For example, the second processing unit 601 may calculate the anchor heat factor H₀ from the following expression (3).

$${H}_{0} = 0.5 \cdot \frac{{N}_{bsi}}{{R}_{bsi}^{2}} + 0.5 \cdot \frac{{N}_{bs ( i + 1 )}}{{R}_{bs ( i + 1 )}^{2}} \qquad ( 3 )$$

In expression (3), N_{bsi} is a first number of spectrum acquisition electronic devices corresponding to a first radius R_{bsi} in the first heat vector, and N_{bs(i+1)} is a second number of spectrum acquisition electronic devices corresponding to a second radius R_{bs(i+1)} in the first heat vector.

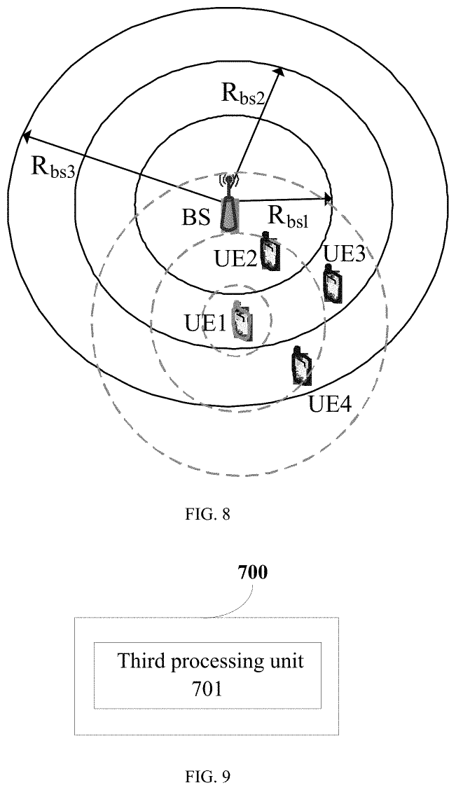

FIG. 8 is a schematic diagram illustrating the first plurality of concentric circles and the second plurality of concentric circles according to an embodiment of the present disclosure. In FIG. 8, BS denotes the management electronic device, UE1 denotes the spectrum providing electronic device 600, and UE2 to UE4 each denote the spectrum acquisition electronic device. As shown in FIG. 8, three concentric circles (with radii R_{bs1}, R_{bs2}, and R_{bs3}, respectively) drawn in solid lines with BS as the center of the circle represent the first plurality of concentric circles. The three concentric circles with UE1 as the center drawn with dashed lines represent the second plurality of concentric circles. In FIG. 8, UE1 is located between the first concentric circle having the first radius R_{bs1} and the second concentric circle having the second radius R_{bs2} among the first plurality of concentric circles.

As described above, the second processing unit 601 calculates the current heat factor Hₒₜ based on the radius corresponding to each of the second plurality of concentric circles and the numbers of spectrum acquisition electronic devices corresponding to the radius respectively included in the second heat vector.

For example, the second processing unit 601 may be configured to, for each radius in the second heat vector, divide the number of spectrum acquisition electronic devices corresponding to the radius included in the second heat vector by a square of the radius, to obtain a distribution density of spectrum acquisition electronic devices corresponding to the concentric circle, and calculate a weighted summation of the distribution densities corresponding to the concentric circles, thereby calculating the current heat factor Hₒₜ.

For ease of illustration, in the following, it is assumed that T is 3, i.e., the second plurality of concentric circles with the spectrum providing the electronic device 600 as the center include three concentric circles. Then, the second heat vector may be expressed as (Rₛ₁, N₁, Rₛ₂, N₂, Rₛ₃, N₃).

The second processing unit 601 may calculate the current heat factor from the following expression (4).

$${H}_{ot} = {p}_{1} \cdot \frac{{N}_{1}}{{R}_{s 1}^{2}} + {p}_{2} \cdot \frac{{N}_{2}}{{R}_{s 2}^{2}} + {p}_{3} \cdot \frac{{N}_{3}}{{R}_{s 3}^{2}} \qquad ( 4 )$$

In expression (4), p₁, p₂, p₃ are weighting factors corresponding to different concentric circles, indicating contributions of distribution densities of the spectrum acquisition electronic device calculated for the different concentric circles in the current heat factor, and p₁+p₂+p₃=1.

For example, the second processing unit 601 may be configured to: assign the same weighting factor to the distribution density corresponding to each concentric circle; or assign a weighting factor to the distribution density corresponding to each concentric circle based on the radius of that concentric circle.

For example, depending on practical situations, p₁, p₂, and p₃ may be equal (e.g., both having a value of 0.33), indicating that the distribution density of the spectrum acquisition electronic devices calculated with different concentric circles has the same contribution in the current heat factor. Alternatively, the weighting factors corresponding to the concentric circle may be gradually reduced as the radius of the concentric circle becomes larger. For example, in the case of Rₛ₁<Rₛ₂<Rₛ₃, the values of p₁, p₂, p₃ corresponding to Rₛ₁, Rₛ₂, and Rₛ₃, respectively, may be 0.46, 0.33, 0.2, indicating that the distribution density of spectrum acquisition electronic devices calculated with a concentric circle of smaller radius has a greater contribution in the current heat factor.

For example, the second processing unit 601 may be configured to calculate, for each of the first plurality of concentric circles, a distribution density of spectrum acquisition electronic devices corresponding to the concentric circle based on a radius corresponding to the concentric circle and the number of spectrum acquisition electronic devices corresponding to the radius in the first heat vector, and determine a highest distribution density among the calculated distribution densities as a highest heat factor Hₘ, and determine a selling price based on the maximum heat factor Hₘ.

The second processing unit 601 may calculate the highest heat factor Hₘ from the following expression (5).

$${H}_{m} = max \{ \frac{{N}_{bs 1}}{{R}_{bs 1}^{2}} , \frac{{N}_{bs 2}}{{R}_{bs 2}^{2}} , … , \frac{{N}_{bsQ}}{{R}_{bsQ}^{2}} \} \qquad ( 5 )$$

In expression (5), R_{bs1}, R_{bs2}, . . . , R_{bsQ} are the radii included in the first heat vector. N_{bs1}, N_{bs2}, . . . , N_{bsQ} are the number of spectrum acquisition electronic devices corresponding to R_{bs1}, R_{bs2}, . . . , R_{bsQ}, respectively included in the first heat vector.

$$max \{ \frac{{N}_{bs 1}}{{R}_{bs 1}^{2}} , \frac{{N}_{bs 2}}{{R}_{bs 2}^{2}} , … , \frac{{N}_{bsQ}}{{R}_{bsQ}^{2}} \}$$

denotes the maximum among

$$\frac{{N}_{bs 1}}{{R}_{bs 1}^{2}} , \frac{{N}_{bs 2}}{{R}_{bs 2}^{2}} , … , \frac{{N}_{bsQ}}{{R}_{bsQ}^{2}}$$

is selected as Hₘ.

The second processing unit 601 may calculate the selling price Y_{obj} from the following expression (6).

$${Y}_{obj} = \frac{{Y}_{min} + {Y}_{max}}{2} + ( {H}_{ot} - {H}_{0} ) \frac{{Y}_{max} + {Y}_{min}}{2 ( {H}_{m} - {H}_{0} )} \qquad ( 6 )$$

From the expression (6), the spectrum providing electronic device 600 maps the current heat factor Hₒₜ and the anchor heat factor H₀ obtained based on the first heat vector and the second heat vector to the selling price, so that the selling price can be reasonably calculated.

The second processing unit 601 may determine the interval in which Y_{obj} is within the range of the lowest price Yₘᵢₙ to the highest price of Yₘₐₓ as the selling price interval. For example, in a case of Yⱼ≤Y_{obj}≤Yⱼ₊₁, the second processing unit 601 may determine the selling price interval of the spectrum providing electronic device 600 to be [Yⱼ, Yⱼ₊₁] (where j=0, 1, . . . M−1).

For example, the first distribution attribute is characterized by a first quadrant vector. The first quadrant vector indicates the numbers of the spectrum acquisition electronic devices respectively included in four quadrants of each of a third plurality of concentric circles of which a center is the management electronic device, in the first region. The second distribution attribute is characterized by a second quadrant vector. The second quadrant vector indicates the numbers of the spectrum acquisition electronic devices respectively included in four quadrants of a circle of which a center is the spectrum providing electronic device 600, in the second region. The first quadrant vector is for measuring partition density of the spectrum acquisition electronic devices around the management electronic device in different quadrants. The second quadrant vector is for measuring partition density of the spectrum acquisition electronic devices around the spectrum providing electronic device 600 in different quadrants.

The four quadrants are illustrated in FIG. 7. As mentioned above, in FIG. 7, X+ and X. denote the positive and negative directions of the X-axis, respectively. Y+ and Y− denote the positive and negative directions of the Y-axis, respectively. Then, the four quadrants are represented by X+Y+, Y+X−, X−Y−, and Y−X+.

For example, the third plurality of concentric circles may be the same as or different from the first plurality of concentric circles described above.

It is assumed that the radii of the third plurality of concentric circles centered on th management electronic device (e.g., a base station) are R_{pbs1}, R_{pbs2}, . . . , R_{pbsK} (K is a positive integer greater than or equal to 1) sequentially, and the number of spectrum acquisition electronic devices included in the four quadrants of the k^{th} concentric circle among the third plurality of concentric circles are V_{pbs1_k}, V_{pbs2_k}, V_{pbs3_k}, V_{pbs4_k} sequentially, where k=1, 2, . . . K. Then, the first quadrant vector may be expressed as (R_{pbs1}, V_{pbs1_1}, V_{pbs2_1}, V_{pbs3_1}, V_{pbs4_1}, R_{pbs2}, V_{pbs1_2}, V_{pbs2_2}, V_{pbs3_2}, V_{pbs4_2}, . . . , R_{pbsk}, V_{pbs1_k}, V_{pbs2_k}, V_{pbs3_k}, V_{pbs4_k}, . . . , R_{pbsK}, V_{pbs1_K}, V_{pbs2_K}, V_{pbs3_K}, V_{pbs4_K}).

It is assumed that the radius of the circle with the spectrum providing electronic device 600 as the center is denoted as Rₚₛ, and the numbers of spectrum acquisition electronic devices included in four quadrants of the circle are Vₚₛ₁, Vₚₛ₂, Vₚₛ₃, and Vₚₛ₄, respectively. Then, the second quadrant vector may be denoted as (Rₚₛ, Vₚₛ₁, Vₚₛ₂, Vₚₛ₃, Vₚₛ₄). For example, in a case that Rₚₛ is equal to R_{S3} illustrated in FIG. 7, the numbers of spectrum acquisition electronic devices Vₚₛ₁, Vₚₛ₂, Vₚₛ₃, and Vₚₛ₄ included in the four quadrants X+Y+, Y+X−, X−Y−, and Y−X+ are 1, 1, 1, and 5, respectively. Then, the second quadrant vector may be expressed as (RS3, 1, 1, 1, 5).

For example, the second processing unit 601 may be configured to: in the case of determining that the spectrum providing electronic device 600 is located between a third concentric circle having a third radius and a fourth concentric circle having a fourth radius greater than the third radius among the third plurality of concentric circles, calculate, based on the third radius and the number of spectrum acquisition electronic devices respectively included in the four quadrants corresponding to the third radius in the first quadrant vector, an anchor quadrant factor H_{q} indicating a distribution density of the spectrum acquisition electronic devices at a location within the first region in which the spectrum providing electronic device 600 is located; calculate, based on the radius of the circle and the numbers of spectrum acquisition electronic devices respectively included in the four quadrants in the second quadrant vector, a current quadrant factor Hₐₓᵢₛ indicating a distribution density of the spectrum acquisition electronic devices at a location within the second region where the spectrum providing electronic device 600 is located; determine a selling price Y_{obj} corresponding to a current quadrant factor based on a maximum price Yₘₐₓ and a minimum price Yₘᵢₙ in the predetermined price list and an anchor quadrant factor; and determine an interval in which the selling price Y_{obj} falls within a range from the minimum price to the maximum price as the selling price interval.

The spectrum providing electronic device 600 can obtain information about the partition distribution of the spectrum acquisition electronic device in each quadrant based on the first quadrant vector and the second quadrant vector, and therefore can determine a more reasonable selling price interval.

As described above, it is assumed that the distance between the spectrum providing electronic device 600 and the management electronic device is dx, where R_{pbsk}<d_{X}<R_{pbs(k+1)}, and R_{pbsk} and R_{pbs(k+1)} denote radii of two adjacent concentric circles among concentric circles of radii R_{pbs1}, R_{pbs2}, . . . , R_{pbsK} centered on the management electronic device, where 1≤k≤K−1. The second processing unit 601 may determine, based on the distance dx, that the spectrum providing electronic device 600 is located between a third concentric circle having a third radius R_{pbsk} and a fourth concentric circle having a fourth radius R_{pbs(k+1)} among the third plurality of concentric circles.

For example, the second processing unit 601 may calculate the anchor quadrant factor H_{q} from the following expression (7).

$${H}_{q} = {q}_{1} \cdot \frac{{V}_{pbs 1\_ k}}{{{R}^{2}}_{pbsk}} + {q}_{2} \cdot \frac{{V}_{pbs 2\_ k}}{{{R}^{2}}_{pbsk}} + {q}_{3} \cdot \frac{{V}_{pbs 3\_ k}}{{{R}^{2}}_{pbsk}} + {q}_{4} \cdot \frac{{V}_{pbs 4\_ k}}{{{R}^{2}}_{pbsk}} \qquad ( 7 )$$

In expression (7), V_{pbs1_k}, V_{pbs2_k}, V_{pbs3_k}, and V_{pbs4_k} are the numbers of spectrum acquisition electronic devices included in the four quadrants corresponding to the third radius R_{pbsk} of the first quadrant vector, respectively. q₁, q₂, q₃, and q₄ are weighting factors corresponding to the different quadrants and q₁+q₂+q₃+q₄=1. For example, those skilled in the art may determine the values of q₁, q₂, q₃, and q₄ based on practical needs, experience or experimentation, etc.

As described above, the second processing unit 601 calculates the current quadrant factor Hₐₓᵢₛ based on the radius of the circle and the number of spectrum acquisition electronic devices included in each of the four quadrants included in the second quadrant vector.

For example, the second processing unit 601 may be configured to divide, the number of spectrum acquisition electronic devices included in each of the four quadrants in the second quadrant vector by a square of the radius of the circle to obtain a distribution density of spectrum acquisition electronic devices corresponding to each quadrant, and calculate a weighted summation of the distribution density corresponding to each quadrant, to calculate the current quadrant factor Hₐₓᵢₛ.

For example, the second processing unit 601 may calculate the current quadrant factor Hₐₓᵢₛ from the following expression (8).

$${H}_{axis} = {q}_{1} \cdot \frac{{V}_{ps 1}}{{{R}^{2}}_{ps}} + {q}_{2} \cdot \frac{{V}_{ps 2}}{{{R}^{2}}_{ps}} + {q}_{3} \cdot \frac{{V}_{ps 3}}{{{R}^{2}}_{ps}} + {q}_{4} \cdot \frac{{V}_{ps 4}}{{{R}^{2}}_{ps}} \qquad ( 8 )$$

In expression (8), Rₚₛ, Vₚₛ₁, Vₚₛ₂, Vₚₛ₃, and Vₚₛ₄ are the radius of the circle with the spectrum providing electronic device 600 as the center, and the numbers of spectrum acquisition electronic devices included in the four quadrants of the circle, respectively. q₁, q₂, q₃, and q₄ are weighting factors corresponding to the different quadrants, and q₁+q₂+q₃+q₄=1. For example, those skilled in the art may determine the values of q₁, q₂, q₃, and q₄ based on practical needs, experience or experimentation, etc.

For example, the second processing unit 601 may be configured to calculate, for each of the third plurality of concentric circles, a distribution density of spectrum acquisition electronic devices corresponding to each of the four quadrants of the concentric circle based on the radius corresponding to the concentric circle included in the first quadrant vector and the number of spectrum acquisition electronic devices in the quadrant corresponding to the radius in the first quadrant vector, determine a highest distribution density of the calculated distribution densities as a highest quadrant factor, and determine the selling price based on the highest quadrant factor.

For example, the second processing unit 601 may calculate the highest quadrant factor from the following expression (9).

$${H}_{pm} = max ( \frac{{V}_{pbs 1\_ k}}{{{R}^{2}}_{pbsk}} , \frac{{V}_{pbs 2\_ k}}{{{R}^{2}}_{pbsk}} , \frac{{V}_{pbs 3\_ k}}{{{R}^{2}}_{pbsk}} , \frac{{V}_{pbs 4\_ k}}{{{R}^{2}}_{pbsk}} ) \qquad ( 9 )$$

In expression (9), 1≤k≤K, R_{pbsk}, V_{pbs1_k}, V_{pbs2_k}, V_{pbs3_k}, and V_{pbs4_k} are the radius R_{pbsk} corresponding to the k^{th} concentric circle, and the numbers of spectrum acquisition electronic devices included in the four quadrants corresponding to that concentric circle respectively in the first quadrant vector.

$$max ( \frac{{V}_{pbs 1\_ k}}{{{R}^{2}}_{pbsk}} , \frac{{V}_{pbs 2\_ k}}{{{R}^{2}}_{pbsk}} , \frac{{V}_{pbs 3\_ k}}{{{R}^{2}}_{pbsk}} , \frac{{V}_{pbs 4\_ k}}{{{R}^{2}}_{pbsk}} )$$

indicates a maximum among

$$\frac{{V}_{pbs 1\_ k}}{{{R}^{2}}_{pbsk}} ,$$

$$\frac{{V}_{pbs 2\_ k}}{{{R}^{2}}_{pbsk}} ,$$

$$\frac{{V}_{pbs 3\_ k}}{{{R}^{2}}_{pbsk}} ,$$

$$\frac{{V}_{pbs 4\_ k}}{{{R}^{2}}_{pbsk}} ,$$

where (1≤k≤K).

The second processing unit 601 may calculate the selling price Y_{pobj} from the following expression (10).

$${Y}_{pobj} = \frac{{Y}_{min} + {Y}_{max}}{2} + ( {H}_{axis} - {H}_{q} ) \frac{{Y}_{max} + {Y}_{min}}{2 ( {H}_{pm} - {H}_{q} )} \qquad ( 10 )$$

From the expression (10), the spectrum providing electronic device 600 maps the current quadrant factor Hₐₓᵢₛ and the anchor quadrant factor H_{q}, obtained based on the first quadrant vector and the second quadrant vector, to the selling price, so that the selling price can be reasonably calculated.

The second processing unit 601 may determine the interval in which Y_{pobj} is within the range of the lowest price Yₘᵢₙ to the highest price of Yₘₐₓ as the selling price interval. For example, in a case of Yⱼ≤Y_{pobj}≤Yⱼ₊₁, the second processing unit 601 may determine the selling price interval of the spectrum providing electronic device 600 to be [Yⱼ, Yⱼ₊₁] (where j=0, 1, . . . M−1).

For example, the spectrum providing electronic device 600 is a subject in a spectrum management system configured as a blockchain architecture. In addition to the spectrum providing electronic device 600, the spectrum management system includes at least one of a management electronic device, a spectrum acquisition electronic device, and other electronic devices.

For the spectrum management system configured as a blockchain architecture, reference is made to the description of the management electronic device 100 according to the present disclosure, and which is not repeated here.

According to another embodiment of the present disclosure, there is also provided a spectrum acquisition electronic device 700 for wireless communication. FIG. 9 is a block diagram illustrating functional modules of the spectrum acquisition electronic device 700 for wireless communication according to an embodiment of the present disclosure. As shown in FIG. 9, the spectrum acquisition electronic device 700 includes a third processing unit 701. The third processing unit 701 may be configured to determine, based on distribution attributions of spectrum acquisition electronic devices in a region taking a management electronic device as a reference point, an offer for a spectrum to be traded in spectrum trade related to the spectrum acquisition electronic device, for performing the spectrum trade. The management electronic device is an electronic device that manages the spectrum acquisition electronic device 700.

The third processing unit 701 may be implemented by one or more processing circuitries which may be implemented as, for example, a chip.

The spectrum acquisition electronic device 700 may, for example, be arranged on the user equipment side or communicatively connected to the user equipment. For example, the spectrum acquisition electronic device 700 may operate as the user equipment itself and may also include external devices such as a memory, a transceiver (not shown in the drawings), etc. The memory may be configured to store programs to be executed by the user equipment to implement various functions and related data information. The transceiver may include one or more communication interfaces to support communication with different devices (e.g., a base station, and another user equipment), and the form of implementation of the transceiver is not specifically limited herein.

The spectrum acquisition electronic device 700 may, for example, be arranged on a base station side or communicatively connected to a base station. For example, the spectrum acquisition electronic device 700 may operate as the base station itself and may also include external devices such as a memory, a transceiver (not shown), etc. The memory may be configured to store programs to be executed by the base station to achieve various functions and related data information. The transceiver may include one or more communication interfaces to support communication with different devices (e.g., user equipment, another base station, etc.), and the form of implementation of the transceiver is not specifically limited herein.

Examples of the management electronic device, the spectrum providing electronic device, and the spectrum acquisition electronic device 700 has described in the embodiments of the management electronic device 100 above and thus are not repeated here. In the following, the description is made with the management electronic device being a base station, and the spectrum acquisition electronic device 700 and the spectrum providing electronic device each being UE.

The region with the management electronic device as a reference point may be any shaped region with the management electronic device as a reference point, for example, an region of any shape centered on the management electronic device (e.g., a circular region or a rectangular region).

For example, multiple spectrums to be traded exist within the management range of the management electronic device. The management electronic device may determine the distribution attribute of the spectrum acquisition electronic device corresponding to the multiple spectrums to be traded within the region. The spectrum acquisition electronic device 700 may determine an offer for the spectrum to be traded in a spectrum trade related to the spectrum acquisition electronic device 700 based on the distribution attribute.

The existing spectrum acquisition electronic device fails to consider the distribution attribute of the spectrum acquisition electronic devices when determining the offer of the spectrum. Instead, the spectrum acquisition electronic device 700 according to embodiments of the present disclosure is capable of determining a reasonable offer for spectrum to be traded based on the distribution attribute, so as to facilitate the spectrum trade, thereby improving the spectrum efficiency of the system.

For example, the distribution attribute may be characterized by a heat vector. The heat vector represents the numbers of spectrum acquisition electronic devices respectively included in a first plurality of concentric circles in the region with the management electronic device as the center of the circle. The heat vector is for measuring the global density of spectrum acquisition electronic devices around the management electronic devices within each of the first plurality of concentric circles.

The first plurality of concentric circles in this embodiment are the same as the first plurality of concentric circles described in the spectrum providing electronic device 600 according to embodiments of the present disclosure and thus are not repeated here. The heat vector may refer to the description of the first heat vector (R_{bs1}, N_{bs1}, R_{bs2}, N_{bs2}, . . . , R_{bsQ}, N_{bsQ}) (Q is a positive integer greater than or equal to 1) in the spectrum providing electronic device 600 according to embodiments of the present disclosure, and thus is not repeated here.

For example, the third processing unit 701 may be configured to, if it is determined based on the location information within the region described above of the spectrum providing electronic device of the spectrum to be traded that the spectrum providing electronic device is located between a first concentric circle having a first radius and a second concentric circle having a second radius greater than the first radius among the plurality of first concentric circles: estimate, based on the first radius and a first number of spectrum acquisition electronic devices corresponding to the first radius in the heat vector, and the second radius and a second number of spectrum acquisition electronic devices corresponding to the second radius in the heat vector, an anchor heat factor indicating a distribution density of the spectrum acquisition electronic devices at a location in the region where the spectrum providing electronic device is located, estimate a price value corresponding to the anchor heat factor based on the highest price and the lowest price in the predetermined price list, and generate an offer based on the price value.

The spectrum acquisition electronic device 700 reasonably estimates a price value based on a heat vector, for subsequent generation of an offer based on the price value.

It is assumed that the set of spectrum providing electronic devices corresponding to the spectrum acquisition electronic device 700 includes J (where J is a positive integer greater than or equal to 1) spectrum providing electronic devices (for determining the set of spectrum providing electronic devices corresponding to the spectrum acquisition electronic device 700, reference is made to the description in the management electronic device 100 according to embodiments of the present disclosure, and thus is not repeated here). For the j^{th} (1≤j≤J) spectrum providing electronic device in the set of spectrum providing electronic devices, the third processing unit 701 may determine that the spectrum providing electronic device is located between a first concentric circle having a first radius R_{bsi} and a second concentric circle having a second radius R_{bs(i+1)} among multiple first concentric circles based on the location information of the spectrum providing electronic device in the above region. The first radius R_{bsi}, the first number N_{bsi}, the second radius R_{bs(i+1)}, and the second number N_{bs(i+1)} in this embodiment are determined in the same manner as the first radius R_{bsi}, the first number N_{bsi}, the second radius R_{bs(i+1)}, and the second number N_{bs(i+1)} described in conjunction with expression (3) in the spectrum providing electronic device 600 according to embodiments of the present disclosure, respectively, and thus are not repeated here.

Then, for the j^{th} (1≤j≤J) spectrum providing electronic device in the set of spectrum providing electronic devices, the third processing unit 701 may estimate an anchor heat factor Hⱼ (1≤j≤J) corresponding to the spectrum providing electronic device from expression (3).

Afterwards, the third processing unit 701 may estimate the price value corresponding to the anchor heat factor Hⱼ based on the highest price Yₘₐₓ and the lowest price Yₘᵢₙ, as well as generate an offer for the j^{th} (1≤j≤J) spectrum providing electronic device based on the price value.

For example, the third processing unit 701 may be configured to calculate, for each of the first plurality of concentric circles, a distribution density of spectrum acquisition electronic devices corresponding to the concentric circle based on a radius corresponding to the concentric circle and the number of spectrum acquisition electronic devices corresponding to the radius in the heat vector, determine a highest distribution density among the calculated distribution densities as a highest heat factor and a lowest distribution density among the calculated distribution densities as a lowest heat factor, and estimate the price value corresponding to the anchor heat factor based on the highest heat factor and the lowest heat factor.

The highest heat factor Hₘ in this embodiment is the same as the highest heat factor Hₘ described in conjunction with expression (5) in the spectrum providing electronic device 600 according to embodiments of the present disclosure, and thus is not repeated here.

The third processing unit 701 may be configured to calculate the lowest heat factor H_{L} from the following expression (11).

$${H}_{L} = min \{ \frac{{N}_{bs 1}}{{{R}^{2}}_{bs 1}} , \frac{{N}_{bs 2}}{{{R}^{2}}_{bs 2}} , … , \frac{{N}_{bsQ}}{{{R}^{2}}_{bsQ}} \} \qquad ( 11 )$$

In expression (11), R_{bs1}, R_{bs2}, . . . , R_{bsQ} are the radii included in the heat vector. N_{bs1}, N_{bs2}, . . . , N_{bsQ} are the numbers of spectrum acquisition electronic devices corresponding respectively to R_{bs1}, R_{bs2}, . . . , R_{bsQ} included in the heat vector.

$$min \{ \frac{{N}_{bs 1}}{{{R}^{2}}_{bs 1}} , \frac{{N}_{bs 2}}{{{R}^{2}}_{bs 2}} , … , \frac{{N}_{bsQ}}{{{R}^{2}}_{bsQ}} \}$$

indicates a minimum among

$$\frac{{N}_{bs 1}}{{{R}^{2}}_{bs 1}} ,$$

$$\frac{{N}_{bs 2}}{{{R}^{2}}_{bs 2}} , … ,$$

$$\frac{{N}_{bsQ}}{{{R}^{2}}_{bsQ}}$$

is selected as H_{L}.

The third processing unit 701 may be configured to estimate the price value yⱼ corresponding to the anchor heat factor Hⱼ from the following expression (12).

$${y}_{j} = {Y}_{min} + \frac{{H}_{j} - {H}_{L}}{{H}_{m} - {H}_{L}} ( {Y}_{max} - {Y}_{min} ) \qquad ( 12 )$$

In expression (12), Hₘ is the highest heat factor, H_{L} is the lowest heat factor, and 1≤j≤J.

From expression (12), the spectrum acquisition electronic device 700 maps the anchor heat factor Hⱼ obtained based on the heat vector to the price value, so that the price value can be reasonably estimated.

For example, the distribution attribute may be characterized by a first quadrant vector. The first quadrant vector represents the numbers of spectrum acquisition electronic devices respectively included in the four quadrants of each of the third plurality of concentric circles in the region with the management electronic device as the center of the circle. The first quadrant vector is for measuring the partition density of the spectrum acquisition electronic devices around the management electronic device in different quadrants.

The third plurality of concentric circles in this embodiment is the same as the third plurality of concentric circles described in the spectrum providing electronic device 600 according to embodiments of the present disclosure and thus is not repeated here. The first quadrant vector is referred to the description of the first quadrant vector (R_{pbs1}, V_{pbs1_1}, V_{pbs2_1}, V_{pbs3_1}, V_{pbs4_1}, R_{pbs2}, V_{pbs1_2}, V_{pbs2_2}, V_{pbs3_2}, V_{pbs4_2}, . . . , R_{pbsk}, V_{pbs1_k}, V_{pbs2_k}, V_{pbs3_k}, V_{pbs4_k}, . . . , R_{pbsK}, V_{pbs1_K}, V_{pbs2_K}, V_{pbs3_K}, V_{pbs4_K}) (K is a positive integer greater than or equal to 1) in the spectrum providing electronic device 600 according to embodiments of the present disclosure and thus is not repeated here.

For example, the third processing unit 701 may be configured to determine the offer of the spectrum to be traded further based on a second quadrant vector. The second quadrant vector represents the numbers of spectrum acquisition electronic devices respectively included in the four quadrants of a circle centered on the spectrum providing electronic device of the spectrum to be traded. The second quadrant vector is for measuring the partition density of the spectrum acquisition electronic devices around the spectrum providing electronic devices in the different quadrants.

The second quadrant vector may refer to the description of the spectrum providing electronic device 600 according to embodiments of the present disclosure with respect to the second quadrant vector (Rₚₛ, Vₚₛ₁, Vₚₛ₂, Vₚₛ₃, Vₚₛ₄), and thus is not repeated here.

For example, the third processing unit 701 may be configured to calculate, for each of the third plurality of concentric circles, a distribution density of the spectrum acquisition electronic devices corresponding to each quadrant of the concentric circle based on the radius of the concentric circle and the numbers of spectrum acquisition electronic devices included in each of the four quadrants corresponding to the radius in the first quadrant vector, and determine a highest distribution density among the calculated distribution densities as a highest quadrant factor and a lowest distribution density among the calculated distribution densities as a lowest quadrant factor; estimate, based on the radius of the circle and the number of spectrum acquisition electronic devices included in each of the four quadrants included in the second quadrant vector, a current quadrant factor indicating a distribution density of spectrum acquisition electronic devices at a location within the circle where the spectrum providing electronic device is located; estimate a price value corresponding to the current quadrant factor based on the highest price and the lowest price in the predetermined price list, the highest quadrant factor and the lowest quadrant factor; and generate an offer based on the price value.

The spectrum acquisition electronic device 700 reasonably estimates the price value based on the first quadrant vector and the second quadrant vector, for subsequent generation of the offer based on the price value.

The highest quadrant factor Hₚₘ in this embodiment may refer to the highest quadrant factor Hₚₘ described in connection with expression (9) in the spectrum providing electronic device 600 according to embodiments of the present disclosure, and thus is not repeated here.

The third processing unit 701 may calculate the lowest quadrant factor from the following expression (13).

$${H}_{pL} = min ( \frac{{V}_{pbs 1\_ k}}{{{R}^{2}}_{pbsk}} , \frac{{V}_{pbs 2\_ k}}{{{R}^{2}}_{pbsk}} , \frac{{V}_{pbs 3\_ k}}{{{R}^{2}}_{pbsk}} , \frac{{V}_{pbs 4\_ k}}{{{R}^{2}}_{pbsk}} ) \qquad ( 13 )$$

In expression (13), 1≤k≤K, R_{pbsk}, V_{pbs1_k}, V_{pbs2_k}, V_{pbs3_k}, and V_{pbs4_k} are the radius R_{pbsk} corresponding to the kₜₕ concentric circle, and the numbers of spectrum acquisition electronic devices respectively included in the four quadrants corresponding to the kₜₕ concentric circle in the first quadrant vector.

$$min ( \frac{{V}_{pbs 1\_ k}}{{{R}^{2}}_{pbsk}} , \frac{{V}_{pbs 2\_ k}}{{{R}^{2}}_{pbsk}} , \frac{{V}_{pbs 3\_ k}}{{{R}^{2}}_{pbsk}} , \frac{{V}_{pbs 4\_ k}}{{{R}^{2}}_{pbsk}} )$$

indicates a minimum among

$$\frac{{V}_{pbs 1\_ k}}{{{R}^{2}}_{pbsk}} ,$$

$$\frac{{V}_{pbs 2\_ k}}{{{R}^{2}}_{pbsk}} ,$$

$$\frac{{V}_{pbs 3\_ k}}{{{R}^{2}}_{pbsk}} ,$$

$$\frac{{V}_{pbs 4\_ k}}{{{R}^{2}}_{pbsk}}$$

$$( 1 \leq k \leq K ) .$$

It is that assumed that the jₜₕ (1≤j≤J) spectrum providing electronic device in the set of spectrum providing electronic devices corresponds to a second quadrant vector of (Rₚₛ, Vₚₛ₁, Vₚₛ₂, Vₚₛ₃, Vₚₛ₄). Then, the third processing unit 701 may estimate the current quadrant factor Hₚⱼ (1≤j≤J) corresponding to the spectrum providing electronic device from expression (8).

Then, the third processing unit 701 may be configured to estimate the price value yₚⱼ corresponding to the current quadrant factor Hₚⱼ from the following expression (14).

$${y}_{pj} = {Y}_{min} + \frac{{H}_{pj} - {H}_{L}}{{H}_{pm} - {H}_{pL}} ( {Y}_{max} - {Y}_{min} ) \qquad ( 14 )$$

In expression (14), Hₚₘ is the highest quadrant factor, H_{pL} is the lowest quadrant factor, and 1≤j≤J.

From expression (14), the spectrum acquisition electronic device 700 maps the current quadrant factor Hₚⱼ to the price value, thereby reasonably estimating the price value.

For example, the third processing unit 701 may be configured to randomly generate the offer based on a Gaussian distribution, where the price value serves as the mean of the Gaussian distribution; and generate a variance of the Gaussian distribution based on the highest and lowest prices. Randomly generating the offer makes the specific values of the offer unpredictable and allows for variability in the offer from the spectrum acquisition electronic devices, thereby helping the spectrum providing electronic device to determine the spectrum acquisition electronic device with which to trade.

For example, the third processing unit 701 may randomly generate an offer for the spectrum of the j^{th} (1≤j≤J) spectrum providing electronic device based on a Gaussian distribution φ(yᵢ, a²) with a mean of yⱼ or yₚⱼ and a variance of a². For example, a is equal to (Yₘₐₓ−Yₘᵢₙ)/M, where M is the number of intervals in the price list.

Further, the third processing unit 701 may not bid on some spectrum providing electronic devices in the set of spectrum providing electronic devices, e.g., yⱼ or yₚⱼ may be equal to 0 with a predetermined probability.

For example, the spectrum acquisition electronic device 700 is a subject in a spectrum management system configured as a blockchain architecture. In addition to the spectrum acquisition electronic device 700, at least one of a management electronic device, a spectrum providing electronic device, and other electronic devices is included in the spectrum management system.

The spectrum management system configured as a blockchain architecture may be referred to the description of the management electronic device 100 according to the present disclosure and thus is not repeated here.

Assuming that the spectrum acquisition electronic device 700 has a number of spectrum coins C, its offers for the spectrum of J=3 spectrum providing electronic devices are Y1, Y2, Y3 sequentially, and there is Y1+Y2+Y3<C. When the sum of Y1, Y2, and Y3 exceeds C, these offers are discarded and new offers are generated randomly. If the sum of the new offers still exceeds C, the offers are discarded.

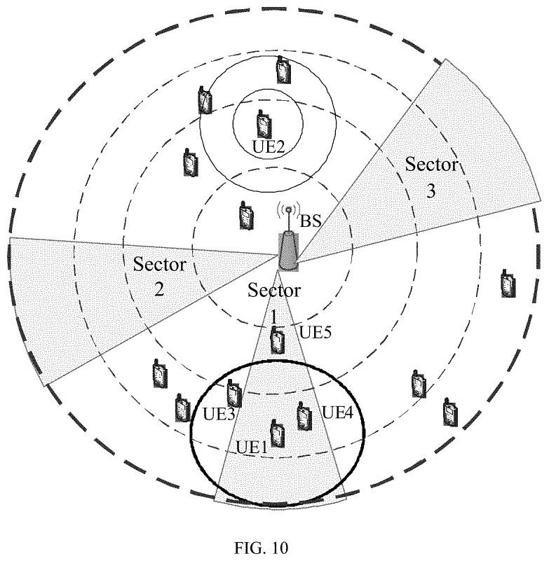

An application scenario of a spectrum management system according to an embodiment of the present disclosure is briefly described below. FIG. 10 is a diagram illustrating an application scenario of a spectrum management system according to an embodiment of the present disclosure. In FIG. 10, description is made with the distribution attribute characterized by a heat vector. It is assumed that the management electronic device is a base station BS, and a sector 1, a sector 2, and a sector 3 of the BS are schematically illustrated in FIG. 10. It is assumed that the set of spectrum providing electronic devices corresponding to the spectrum acquisition electronic device UE1 is determined to include UE3 and UE4 based on at least one of the first condition and the second condition described in the embodiment of the management electronic device 100. The UE2, illustrated in FIG. 10, is a spectrum providing electronic device that is not included in the set of spectrum providing electronic devices corresponding to the UE1. UE5 may be one of the following: a spectrum providing electronic device, a spectrum acquisition electronic device, and other electronic device other than a management electronic device, a spectrum providing electronic device, and a spectrum acquisition electronic device. It is assumed that the electronic device illustrated by the “cellphone” diagram in FIG. 10 and not marked in a symbol is a spectrum acquisition electronic device. The initial number of spectrum coins for each electronic device in FIG. 10 is 10.

In FIG. 10, the first plurality of concentric circles with BS as the center includes 4 concentric circles (shown as dashed lines). Ii is assumed that the first heat vector (R_{bs1}, N_{bs1}, R_{bs2}, N_{bs2}, . . . , R_{bsQ}, N_{bsQ}) (Q=4) may be expressed as (500, 1, 1000, 3, 1500, 9, 2000, 11).

The determination of the selling price interval of the UE2 is first briefly exemplified. In FIG. 10, the second plurality of concentric circles with UE2 as the center include 2 concentric circles (shown as solid lines). It is assumed that the second heat vector (Rₛ₁, N₁, Rₛ₂, N₂, . . . , R_{sT}, N_{T}) of the UE2 (T=2) may be expressed as (250, 0, 500, 2). The values of the spectrum coin price bands are: 1, 3, 5, 7. As can be seen from FIG. 10, the UE2 is located between a circle with a radius of 500 m and a circle with a radius of 1000 m both centered on the BS. The anchor heat factor corresponding to the UE2 is calculated as H₀=0.5*1/500²+0.5*3/1000²=3.5e-6 from expression (3). The highest heat factor is calculated as Hₘ=4e-6 from expression (5). The current heat factor is calculated as Hₒₜ=0.5*0/250²+0.5*2/500²=4e-6 from expression (4). The selling price is calculated as Y_{obj}=(1+7)/2+(4e-6-3.5e-6)*6/(4e-6-3.5e-6)/2=7 from expression (6). Therefore, it can be determined that the selling price interval of the UE2 is [5, 7] spectrum coins.

The following is a brief example of the determination of the offer of the UE1. The UE1 estimates the anchor heat factor H₃=0.5*3/1000²+0.5*9/1500²=3.5e-6 corresponding to the UE3 based on the location information of UE3 from expression (3); estimates the anchor heat factor H₄=0.5*3/1000²+0.5*9/1500²=3.5e-6 corresponding to the UE4 based on the location information of UE4 from expression (3); and calculates the lowest heat factor H_{L}=11/2000²=2.75e-6 from expression (11). Then, the UE1 calculates the price value y₃=4.6 for the UE3 and the price value y₄=4.6 for the UE4 from expression (12). The UE1 randomly generates an offer based on the Gaussian distribution with y₃ as the mean. It is assumed that the offer for the UE3 is 5.03. The UE1 randomly generates an offer based on the Gaussian distribution with y₄ as the mean. It is assumed that the offer for the UE4 is 3.94.

The following is a brief example of the matching performed by the management electronic device for the selling price interval and the offer.

It is assumed that the UE3 receives an offer of 5.03 from the UE1 and 3.4 from an unknown electronic device 1 (not shown in FIG. 10) and 2.1 from an unknown electronic device 2 (not shown in FIG. 10).

It is assumed that the selling price interval of the spectrum providing electronic device UE3 is [3,5]. Since the offer of 3.4 of the unknown electronic device 1 lies within the selling price interval [3,5], the unknown electronic device 1 reaches a deal with the UE3.

It is assumed that the selling price interval of the UE3 is [1,3]. Since the offer of 2.1 of the unknown electronic device 2 lies within the selling price interval [1,3], the unknown electronic device 2 reaches a deal with the UE3.

It is assumed that the selling price interval of the UE3 is [5,7]. Since the offer of 5.03 of the UE1 lies within the selling price interval [5,7], the UE1 reaches a deal with the UE3.

It is assumed that UE4 receives only an offer of 3.94 from the UE1, and a selling price interval of UE4 is [5,7]. In this case, the base station provides offers (3.94+5)/2=4.47, 3.94 and 5 to the UE1 and the UE4. The UE1 or the UE4 may agree to at least one of these 3 offers, or neither of them. When the selection of these 3 offers by the UE1 intersects with the selection of these 3 offers by the UE4, the largest of the selected common offers is determined as the selling price. For example, UE4 receives only offer of 3.94 from the UE1, and a selling price interval of the UE4 is [1, 3]. Then UE1 and UE4 reach a deal at a price of 3.94.

The management electronic device records all proposed trades in a block and then sends the block to all electronic devices. It is assumed that there are S (S is a positive integer greater than or equal to 1) trades in the block. For any electronic device, the S transactions are divided into three categories. One is the trade in which the electronic device participates as a spectrum acquisition electronic device (buyer) or a spectrum providing electronic device (seller), which is noted here as the first type of trade. Another is that the electronic device may be affected by interference due to the occurrence of the trade, which is recorded here as the second type of trade. The last is one in which the electronic device has no interaction with the trade at all, and is recorded here as the third type of trade. For the first type of trade, the electronic device verifies the spectrum price, spectrum resource attribute, etc. of the trade. In a case of successful verification, the verification is completed and a reward of 1 spectrum coin is obtained, for example. For the second type of trade, the electronic device verifies the trade by the verification of interference. If the occurrence of the trade causes harmful interference to the communication of the electronic device, the electronic device disagrees with the trade. If the trade occurs with negligible interference to the communication of the electronic device, the electronic device agrees to the trade. For example, a reward of 0.5 spectrum coins is obtained. For the third type of trade, the electronic device does not make any verification and does not receive spectrum coins as a reward.

The managing electronic device determines legitimate and illegitimate transactions by voting after collecting verification information from the electronic devices for the transactions within the block. The electronic device that is the buyer or seller has one vote against this trade. Other electronic devices related this trade (i.e., electronic devices that may be affected by interference due to the occurrence of the trade) determines whether the trade is legitimate or illegitimate based on majority-minority vote. The managing electronic device writes the legitimate trade into a new block and distributes the block to the electronic devices.

In describing the management electronic device for wireless communication, the spectrum providing electronic device for wireless communication, and the spectrum acquisition electronic device for wireless communication in the embodiments above, it is apparent that some processing or methods are also disclosed. In the following, an outline of these methods is given without repeating some of the details already discussed above. However, it should be noted that while these methods are disclosed in the description of the management electronic device for wireless communication, the spectrum providing electronic device for wireless communication, and the spectrum acquisition electronic device for wireless communication, these methods do not necessarily employ the components described or are not necessarily performed by those components. For example, implementations of the management electronic device for wireless communication, the spectrum providing electronic device for wireless communication, and the spectrum acquisition electronic device for wireless communication may be implemented partially or completely by hardware and/or firmware. The methods for wireless communication discussed below may be implemented entirely by computer-executable programs, although these methods may also employ hardware and/or firmware for management electronic device for wireless communication, the spectrum providing electronic device for wireless communication, and the spectrum acquisition electronic device for wireless communication.

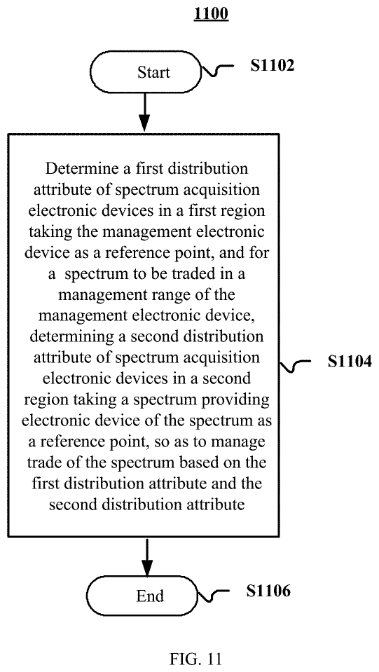

FIG. 11 illustrates a flowchart of a method 1100 for wireless communication according to an embodiment of the present disclosure. The method 1100 begins at step S1102. In step S1104, a first distribution attribute of spectrum acquisition electronic devices in a first region with the management electronic device as a reference point is determined, and a second distribution attribute of spectrum acquisition electronic devices in a second region with the spectrum providing electronic device as a reference point is determined for a spectrum to be traded within the management range of the management electronic device, so as to manage the spectrum trade based on the first distribution attribute and the second distribution attribute. The method 1100 ends at step S1106. The method 1100 may be performed, for example, on the base station or user equipment side.

The method may be performed, for example, by the management electronic device 100 described above, the details of which can be found in the description at the corresponding location above and are not repeated here.

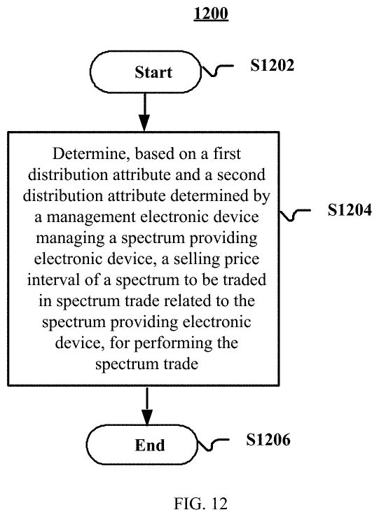

FIG. 12 illustrates a flowchart of a method 1200 for wireless communication according to another embodiment of the present disclosure. The method 1200 begins at step S1202. In step S1204, based on a first distribution attribute and a second distribution attribute determined by a management electronic device that manages a spectrum providing electronic device, a selling price interval of the spectrum to be traded in a spectrum trade related to the spectrum providing electronic device is determined for performing the spectrum trade. The first distribution attribute is a distribution attribute of the spectrum acquisition electronic devices in a first region with the management electronic device as a reference point. The second distribution attribute is a distribution attribute of the spectrum acquisition electronic devices within the second region with the spectrum providing electronic device as the reference point. The method 1200 ends at step S1206. The method 1200 may be performed at the base station side or at the user equipment side.

The method 1200 may be performed, for example, by the spectrum providing electronic device 600 described above, the details of which can be found in the descriptions at the corresponding locations above and are not repeated here.

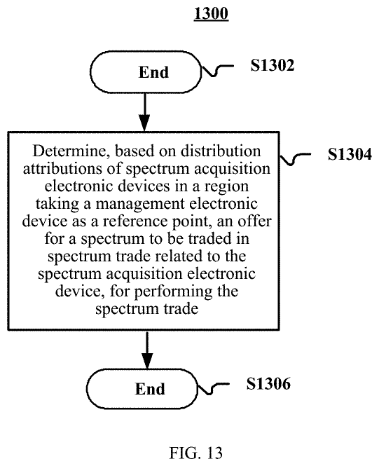

FIG. 13 illustrates a flowchart of a method 1300 for wireless communication according to another embodiment of the present disclosure. The method 1300 begins at step S1302. In step S1304, an offer for spectrum to be traded in a spectrum trade related to a spectrum acquisition electronic device is determined based on a distribution attribute of spectrum acquisition electronic devices in a region with a management electronic device as a reference point, for performing the spectrum trade. The management electronic device is an electronic device that manages the spectrum acquisition electronic device. The method 1300 ends at step S1306. The method 1300 may be performed at the base station side or at the user equipment side.

The method 1300 may be performed, for example, by the spectrum acquisition electronic device 700 described above, the details of which can be found in the description at the corresponding location above and are not repeated here.

Note that, each of the methods may be used in combination or alone.

The technology of the present disclosure can be applied to various products.

For example, the management electronic device 100, the spectrum providing electronic device 600, and the spectrum acquisition electronic device 700 may be implemented as various base stations. The base station may be implemented as any type of evolved Node B (eNB) or gNB (5G base station). An eNB includes, for example, macro eNBs and small eNBs. A small eNB may be an eNB that covers a cell smaller than a macro cell, such as a pico eNB, a micro eNB, and a home (femto) eNB. A similar situation can also apply to gNBs. Alternatively, the base station may be implemented as any other type of base station, such as a NodeB and a base transceiver station (BTS). The base station may include: a main body (also referred to as base station equipment) configured to control wireless communications; and one or more remote radio heads (RRHs) arranged at a different place from the main body. In addition, various types of user equipment can all operate as base stations by temporarily or semi-persistently performing base station functions.

For example, the management electronic device 100, the spectrum providing electronic device 600, and the spectrum acquisition electronic device 700 may be implemented as various user equipment. The user equipment may be implemented as a mobile terminal (such as a smart phone, a tablet personal computer (PC), a notebook PC, a portable game terminal, a portable/dongle type mobile router, and a digital camera) or a vehicle-mounted terminal (such as an automobile navigation device). The user equipment may also be implemented as a terminal (also referred to as a machine type communication (MTC) terminal) that executes Machine-to-Machine (M2M) communications. In addition, the user equipment may be a wireless communication module (such as an integrated circuit module including a single chip) installed on each of the above-mentioned terminals.

### Application Examples about Base Station

### First Application Example

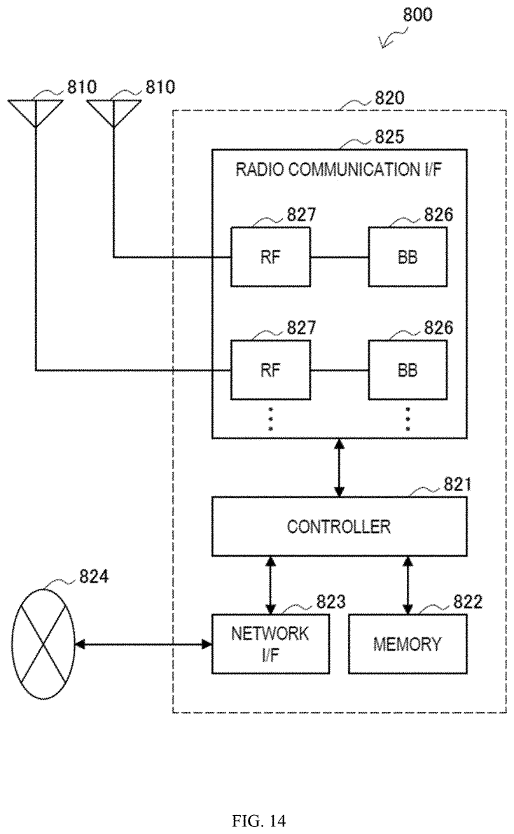

FIG. 14 is a block diagram showing a first example of a schematic configuration of an eNB or gNB to which the technology of the present disclosure can be applied. Note that, the following description takes an eNB as an example, but it may also be applied to a gNB. An eNB 800 includes one or more antennas 810 and base station equipment 820. The base station equipment 820 and each antenna 810 may be connected to each other via an RF cable.

Each of the antennas 810 includes a single or multiple antenna elements (such as multiple antenna elements included in a Multi-Input Multi-Output (MIMO) antenna), and is used for the base station equipment 820 to transmit and receive wireless signals. As shown in FIG. 14, the eNB 800 may include multiple antennas 810. For example, the multiple antennas 810 may be compatible with multiple frequency bands used by the eNB 800. Although FIG. 14 shows an example in which the eNB 800 includes multiple antennas 810, the eNB 800 may also include a single antenna 810.

The base station equipment 820 includes a controller 821, a memory 822, a network interface (I/F) 823, and a radio communication interface 825.

The controller 821 may be, for example, a CPU or a DSP, and manipulate various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have a logical function for performing control such as radio resource control, radio bearer control, mobility management, admission control, and scheduling. The control may be executed in conjunction with nearby eNBs or core network nodes. The memory 822 includes an RAM and an ROM, and stores programs executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or other eNBs may be connected to each other through a logical interface (such as an S1 interface and an X2 interface). The network interface 823 may also be a wired communication interface, or a wireless communication interface for a wireless backhaul line. If the network interface 823 is a wireless communication interface, the network interface 823 may use a higher frequency band for wireless communications than the frequency band used by the radio communication interface 825.

The radio communication interface 825 supports any cellular communication scheme (such as Long Term Evolution (LTE) and LTE-Advanced), and provides wireless connection to a terminal located in a cell of the eNB 800 via an antenna 810. The radio communication interface 825 may generally include, for example, a baseband (BB) processor 826 and an RF circuit 827. The BB processor 826 may execute, for example, encoding/decoding, modulation/demodulation, and multiplexing/demultiplexing, and execute various types of signal processing of layers (e.g., L1, Medium Access Control (MAC), Radio Link Control (RLC), and Packet Data Convergence Protocol (PDCP)). Instead of the controller 821, the BB processor 826 may have a part or all of the above-mentioned logical functions. The BB processor 826 may be a memory storing a communication control program, or a module including a processor and related circuits configured to execute the program. An update program may cause the function of the BB processor 826 to be changed. The module may be a card or blade inserted into a slot of the base station equipment 820. Alternatively, the module may also be a chip mounted on a card or blade. Meanwhile, the RF circuit 827 may include, for example, a mixer, a filter, and an amplifier, and transmit and receive a wireless signal via the antenna 810.

As shown in FIG. 14, the radio communication interface 825 may include multiple BB processors 826. For example, the multiple BB processors 826 may be compatible with multiple frequency bands used by the eNB 800. As shown in FIG. 14, the radio communication interface 825 may include multiple RF circuits 827. For example, the multiple RF circuits 827 may be compatible with multiple antenna elements. Although FIG. 14 shows an example in which the radio communication interface 825 includes multiple BB processors 826 and multiple RF circuits 827, the radio communication interface 825 may also include a single BB processor 826 or a single RF circuit 827.

In the eNB 800 shown in FIG. 14, the transceivers of the management electronic device 100 described with reference to FIG. 1, the spectrum providing electronic device 600 described with reference to FIG. 6, and the spectrum acquisition electronic device 700 described with reference to FIG. 9 may be implemented by the radio communication interface 825. At least a part of the function may also be implemented by the controller 821. For example, the controller 821 may implement the spectrum trade by performing the functions of the first processing unit 101 described above with reference to FIG. 1, the second processing unit 601 described with reference to FIG. 6, and the third processing unit 701 described with reference to FIG. 9.

### Second Application Example

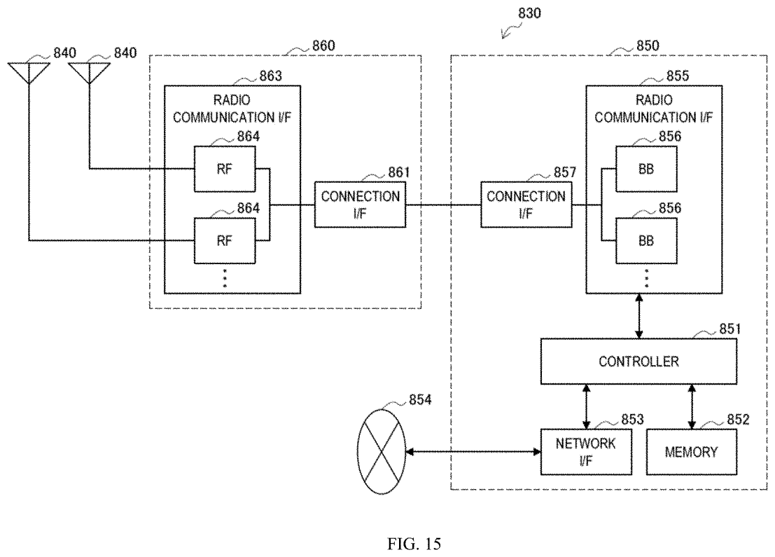

FIG. 15 is a block diagram showing a second example of a schematic configuration of an eNB or gNB to which the technology of the present disclosure can be applied. Note that similarly, the following description takes an eNB as an example, but it may also be applied to a gNB. An eNB 830 includes one or more antennas 840, base station equipment 850, and an RRH 860. The RRH 860 and each antenna 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna) and is used for the RRH 860 to transmit and receive a wireless signal. As shown in FIG. 15, the eNB 830 may include multiple antennas 840. For example, the multiple antennas 840 may be compatible with multiple frequency bands used by the eNB 830. Although FIG. 15 shows an example in which the eNB 830 includes multiple antennas 840, the eNB 830 may also include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 as described with reference to FIG. 14.

The radio communication interface 855 supports any cellular communication scheme (such as LTE and LTE-Advanced), and provides wireless communications to a terminal located in a sector corresponding to the RRH 860 via the RRH 860 and the antenna 840. The radio communication interface 855 may generally include, for example, a BB processor 856. The BB processor 856 is the same as the BB processor 826 as described with reference to FIG. 14 except that the BB processor 856 is connected to the RF circuit 864 of the RRH 860 via the connection interface 857. As shown in FIG. 15, the radio communication interface 855 may include multiple BB processors 856. For example, the multiple BB processors 856 may be compatible with multiple frequency bands used by the eNB 830. Although FIG. 15 shows an example in which the radio communication interface 855 includes multiple BB processors 856, the radio communication interface 855 may also include a single BB processor 856.

The connection interface 857 is an interface for connecting the base station equipment 850 (radio communication interface 855) to the RRH 860. The connection interface 857 may also be a communication module for communication in the above-mentioned high-speed line that connects the RRH 860 to the base station equipment 850 (radio communication interface 855).

The RRH 860 includes a connection interface 861 and a radio communication interface 863.

The connection interface 861 is an interface for connecting the RRH 860 (radio communication interface 863) to the base station equipment 850. The connection interface 861 may also be a communication module for communication in the above-mentioned high-speed line.

The radio communication interface 863 transfers and receives wireless signals via the antenna 840. The radio communication interface 863 may generally include, for example, an RF circuit 864. The RF circuit 864 may include, for example, a mixer, a filter, and an amplifier, and transfer and receive wireless signals via the antenna 840. As shown in FIG. 15, the radio communication interface 863 may include multiple RF circuits 864. For example, the multiple RF circuits 864 may support multiple antenna elements. Although FIG. 15 shows an example in which the radio communication interface 863 includes multiple RF circuits 864, the radio communication interface 863 may also include a single RF circuit 864.

In the eNB 830 as shown in FIG. 15, the transceivers of the management electronic device 100 described with reference to FIG. 1, the spectrum providing electronic device 600 described with reference to FIG. 6, and the spectrum acquisition electronic device 700 described with reference to FIG. 9 may be implemented by the radio communication interface 855. At least a part of the function may also be implemented by the controller 826. For example, the controller 826 may implement the spectrum trade by performing the functions of the first processing unit 101 described above with reference to FIG. 1, the second processing unit 601 described with reference to FIG. 6, and the third processing unit 701 described with reference to FIG. 9.

### Application Example About User Equipment

### First Application Example

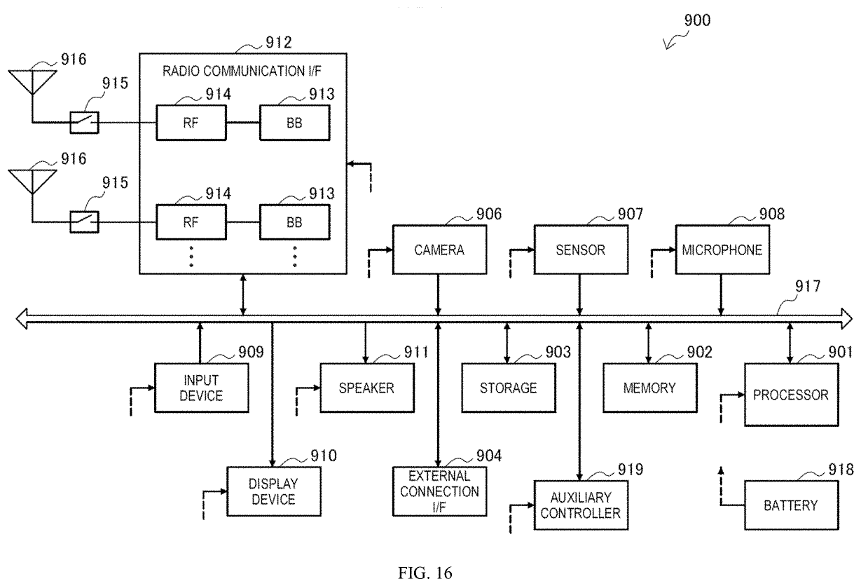

FIG. 16 is a block diagram showing an example of a schematic configuration of a smart phone 900 to which the technology of the present disclosure can be applied. The smart phone 900 includes a processor 901, a memory 902, a storage 903, an external connection interface 904, an camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls the functions of the application layer and other layers of the smart phone 900. The memory 902 includes an RAM and an ROM, and stores data and programs executed by the processor 901. The storage 903 may include a storage medium such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetic sensor, and an acceleration sensor. The microphone 908 converts sound input to the smart phone 900 into an audio signal. The input device 909 includes, for example, a touch sensor, a keypad, a keyboard, a button, or a switch configured to detect a touch on a screen of the display device 910, and receives an operation or information input from the user. The display device 910 includes a screen (such as a liquid crystal display (LCD) and an organic light emitting diode (OLED) display), and displays an output image of the smart phone 900. The speaker 911 converts the audio signal output from the smart phone 900 into sound.

The radio communication interface 912 supports any cellular communication scheme (such as LTE and LTE-Advanced), and executes wireless communications. The radio communication interface 912 may generally include, for example, a BB processor 913 and an RF circuit 914. The BB processor 913 may execute, for example, encoding/decoding, modulation/demodulation, and multiplexing/demultiplexing, and execute various types of signal processing for wireless communications. Meanwhile, the RF circuit 914 may include, for example, a mixer, a filter, and an amplifier, and transmit and receive wireless signals via the antenna 916. Note that, although the figure shows a circumstance where one RF link is connected with one antenna, this is only schematic, and a circumstance where one RF link is connected with multiple antennas through multiple phase shifters is also included. The radio communication interface 912 may be a chip module on which the BB processor 913 and the RF circuit 914 are integrated. As shown in FIG. 16, the radio communication interface 912 may include multiple BB processors 913 and multiple RF circuits 914. Although FIG. 16 shows an example in which the radio communication interface 912 includes multiple BB processors 913 and multiple RF circuits 914, the radio communication interface 912 may also include a single BB processor 913 or a single RF circuit 914.

Furthermore, in addition to the cellular communication scheme, the radio communication interface 912 may support other types of wireless communication schemes, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits included in the radio communication interface 912 (e.g., circuits for different wireless communication schemes).

Each of the antennas 916 includes a single or multiple antenna elements (such as multiple antenna elements included in a MIMO antenna), and is used for the radio communication interface 912 to transmit and receive wireless signals. As shown in FIG. 16, the smart phone 900 may include multiple antennas 916. Although FIG. 16 shows an example in which the smart phone 900 includes multiple antennas 916, the smart phone 900 may also include a single antenna 916.

Furthermore, the smart phone 900 may include an antenna 916 for each wireless communication scheme. In this case, the antenna switch 915 may be omitted from the configuration of the smart phone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to each block of the smart phone 900 as shown in FIG. 16 via a feeder line, which is partially shown as a dashed line in the figure. The auxiliary controller 919 manipulates the least necessary function of the smart phone 900 in a sleep mode, for example.

In the smart phone 900 as shown in FIG. 16, the transceivers of the management electronic device 100 described with reference to FIG. 1, the spectrum providing electronic device 600 described with reference to FIG. 6, and the spectrum acquisition electronic device 700 described with reference to FIG. 9 may be implemented by a radio communication interface 912. At least a part of the function may also be implemented by the processor 901 or the auxiliary controller 919. For example, the processor 901 or the auxiliary controller 919 may implement the spectrum trade by performing the functions of the first processing unit 101 described above with reference to FIG. 1, the second processing unit 601 described with reference to FIG. 6, and the third processing unit 701 described with reference to FIG. 9.

### Second Application Example

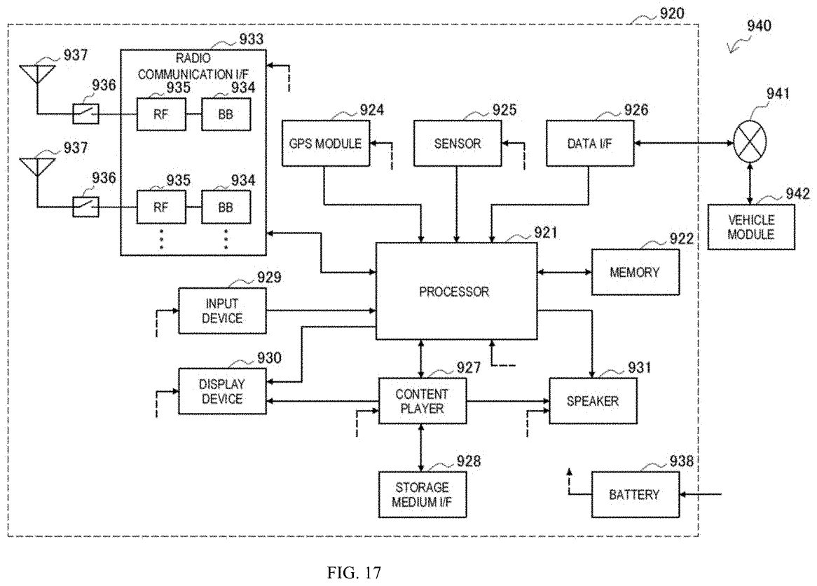

FIG. 17 is a block diagram showing an example of a schematic configuration of automobile navigation equipment to which the technology of the present disclosure can be applied. The automobile navigation equipment 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls the navigation function of the automobile navigation equipment 920 and additional functions. The memory 922 includes an RAM and an ROM, and stores data and programs executed by the processor 921.

The GPS module 924 uses a GPS signal received from a GPS satellite to measure a position of the automobile navigation equipment 920 (such as latitude, longitude, and altitude). The sensor 925 may include a group of sensors, such as a gyro sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD), which is inserted into the storage medium interface 928. The input device 929 includes, for example, a touch sensor, a button, or a switch configured to detect a touch on a screen of the display device 930, and receives an operation or information input from the user. The display device 930 includes a screen such as an LCD or OLED display, and displays an image of a navigation function or reproduced content. The speaker 931 outputs the sound of the navigation function or the reproduced content.

The radio communication interface 933 supports any cellular communication scheme, such as LTE and LTE-Advanced, and executes wireless communication. The radio communication interface 933 may generally include, for example, a BB processor 934 and an RF circuit 935. The BB processor 934 may execute, for example, encoding/decoding, modulation/demodulation, and multiplexing/demultiplexing, and execute various types of signal processing for wireless communications. Meanwhile, the RF circuit 935 may include, for example, a mixer, a filter, and an amplifier, and transmit and receive wireless signals via the antenna 937. The radio communication interface 933 may also be a chip module on which the BB processor 934 and the RF circuit 935 are integrated. As shown in FIG. 17, the radio communication interface 933 may include multiple BB processors 934 and multiple RF circuits 935. Although FIG. 17 shows an example in which the radio communication interface 933 includes multiple BB processors 934 and multiple circuits 935, the radio communication interface 933 may also include a single BB processor 934 or a single RF circuit 935.

Furthermore, in addition to the cellular communication scheme, the radio communication interface 933 may support types of wireless communication schemes, such as a short-range wireless communication scheme, a near field communication scheme, and a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits included in the radio communication interface 933 (e.g., circuits for different wireless communication schemes).

Each of the antennas 937 includes a single or multiple antenna elements (such as multiple antenna elements included in a MIMO antenna), and is used for the radio communication interface 933 to transmit and receive wireless signals. As shown in FIG. 17, the automobile navigation equipment 920 may include multiple antennas 937. Although FIG. 17 shows an example in which the automobile navigation equipment 920 includes multiple antennas 937, the automobile navigation equipment 920 may also include a single antenna 937.

Furthermore, the automobile navigation equipment 920 may include an antenna 937 for each wireless communication scheme. In this case, the antenna switch 936 may be omitted from the configuration of the automobile navigation equipment 920.

The battery 938 supplies power to each block of the automobile navigation equipment 920 as shown in FIG. 17 via a feeder line, which is partially shown as a dashed line in the figure. The battery 938 accumulates electric power supplied from the vehicle.

In the automobile navigation equipment 920 as shown in FIG. 17, the transceivers of the management electronic device 100 described with reference to FIG. 1, the spectrum providing electronic device 600 described with reference to FIG. 6, and the spectrum acquisition electronic device 700 described with reference to FIG. 9 may be implemented by the radio communication interface 933. At least a part of the function may also be implemented by the processor 921. For example, the processor 921 may implement the spectrum trade by performing the functions of the first processing unit 101 described above with reference to FIG. 1, the second processing unit 601 described with reference to FIG. 6, and the third processing unit 701 described with reference to FIG. 9.

The technology of the present disclosure may also be implemented as an in-vehicle system (or vehicle) 940 including one or more blocks in the automobile navigation equipment 920, the in-vehicle network 941, and the vehicle module 942. The vehicle module 942 generates vehicle data (such as vehicle speed, engine speed, and failure information), and outputs the generated data to the in-vehicle network 941.

The basic principle of the present invention has been described above in conjunction with specific embodiments. However, it should be pointed out that, for those skilled in the art, it could be understood that all or any step or component of the methods and devices of the present invention may be implemented in any computing device (including processors, storage media, etc.) or network of computing devices in the form of hardware, firmware, software, or a combination thereof. This can be achieved by those skilled in the art utilizing their basic circuit design knowledge or basic programming skills after reading the description of the present invention.

Moreover, the present invention also proposes a program product storing a machine-readable instruction code that, when read and executed by a machine, can execute the above-mentioned methods according to the embodiments of the present invention.

Accordingly, a storage medium for carrying the above-mentioned program product storing a machine-readable instruction code is also included in the disclosure of the present invention. The storage medium includes, but is not limited to, a floppy disk, an optical disk, a magneto-optical disk, a memory card, a memory stick, etc.

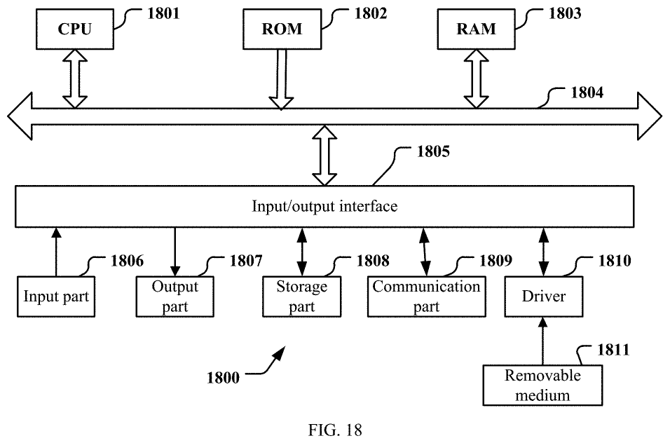

In a case where the present invention is implemented by software or firmware, a program constituting the software is installed from a storage medium or a network to a computer with a dedicated hardware structure (e.g., a general-purpose computer 1800 as shown in FIG. 18), and the computer, when installed with various programs, can execute various functions and the like.

In FIG. 18, a central processing unit (CPU) 1801 executes various processing in accordance with a program stored in a read only memory (ROM) 1802 or a program loaded from a storage part 1808 to a random-access memory (RAM) 1803. In the RAM 1803, data required when the CPU 1801 executes various processing and the like is also stored as needed. The CPU 1801, the ROM 1802, and the RAM 1803 are connected to each other via a bus 1804. The input/output interface 1805 is also connected to the bus 1804.

The following components are connected to the input/output interface 1805: an input part 1806 (including a keyboard, a mouse, etc.), an output part 1807 (including a display, such as a cathode ray tube (CRT), a liquid crystal display (LCD), etc., and a speaker, etc.), a storage part 1808 (including a hard disk, etc.), and a communication part 1809 (including a network interface card such as an LAN card, a modem, etc.). The communication part 1809 executes communication processing via a network such as the Internet. The driver 1810 may also be connected to the input/output interface 1805, as needed. A removable medium 1811 such as a magnetic disk, an optical disk, a magneto-optical disk, a semiconductor memory and the like is installed on the driver 1810 as needed, so that a computer program read out therefrom is installed into the storage part 1808 as needed.

In a case where the above-mentioned series of processing is implemented by software, a program constituting the software is installed from a network such as the Internet or a storage medium such as the removable medium 1811.

Those skilled in the art should understand that, this storage medium is not limited to the removable medium 1811 as shown in FIG. 18 which has a program stored therein and which is distributed separately from an apparatus to provide the program to users. Examples of the removable media 1811 include magnetic disks (including a floppy disk (registered trademark)), an optical disk (including a compact disk read-only memory (CD-ROM) and a digital versatile disk (DVD)), a magneto-optical disk (including a mini disk (MD) (registered trademark)), and a semiconductor memory. Alternatively, the storage medium may be the ROM 1802, a hard disk included in the storage part 1808, etc., which have programs stored therein and which are distributed concurrently with the apparatus including them to users.

It should also be pointed out that in the devices, methods and systems of the present invention, each component or each step may be decomposed and/or recombined. These decompositions and/or recombinations should be regarded as equivalent solutions of the present invention. Moreover, the steps of executing the above-mentioned series of processing may naturally be executed in chronological order in the order as described, but do not necessarily need to be executed in chronological order. Some steps may be executed in parallel or independently of each other.

Finally, it should be noted that, the terms “include”, “comprise” or any other variants thereof are intended to cover non-exclusive inclusion, so that a process, method, article or apparatus that includes a series of elements not only includes those elements, but also includes other elements that are not explicitly listed, or but also includes elements inherent to such a process, method, article, or apparatus. Furthermore, in the absence of more restrictions, an element defined by sentence “including one . . . ” does not exclude the existence of other identical elements in a process, method, article, or apparatus that includes the element.

Although the embodiments of the present invention have been described above in detail in conjunction with the accompanying drawings, it should be appreciated that, the above-described embodiments are only used to illustrate the present invention and do not constitute a limitation to the present invention. For those skilled in the art, various modifications and changes may be made to the above-mentioned embodiments without departing from the essence and scope of the present invention. Therefore, the scope of the present invention is defined only by the appended claims and equivalent meanings thereof.

This technology can also be implemented as follows.

(1). A management electronic device for wireless communication, including:

processing circuitry, where the processing circuitry is configured to:

determine a first distribution attribute of spectrum acquisition electronic devices in a first region taking the management electronic device as a reference point, and for a spectrum to be traded in a management range of the management electronic device, determine a second distribution attribute of spectrum acquisition electronic devices in a second region taking a spectrum providing electronic device of the spectrum as a reference point, so as to manage trade of the spectrum based on the first distribution attribute and the second distribution attribute.

(2). The management electronic device according to (1), wherein

the first distribution attribute is characterized by a first heat vector, wherein the first heat vector indicates numbers of the spectrum acquisition electronic devices respectively included in a first plurality of concentric circles of which a center is the management electronic device, in the first region; and

the second distribution attribute is characterized by a second heat vector, wherein the second heat vector indicates numbers of the spectrum acquisition electronic devices respectively included in a second plurality of concentric circles of which a center is the spectrum providing electronic device, in the second region.

(3). The management electronic device according to (1), wherein

the first distribution attribute is characterized by a first quadrant vector, wherein the first quadrant vector indicates numbers of the spectrum acquisition electronic devices respectively included in four quadrants of each of a third plurality of concentric circles of which a center is the management electronic device, in the first region; and

the second distribution attribute is characterized by a second quadrant vector, wherein the second quadrant vector indicates numbers of the spectrum acquisition electronic devices respectively included in four quadrants of a circle of which a center is the spectrum providing electronic device, in the second region.

(4). The management electronic device according to any one of (1) to (3), wherein the processing circuitry is configured to:

match a selling price interval for the spectrum provided by the spectrum providing electronic device with an offer for the spectrum provided by the spectrum acquisition electronic device which is to acquire the spectrum, wherein

the spectrum providing electronic device provides the selling price interval based on the first distribution attribute and the second distribution attribute, and the spectrum acquisition electronic device which is to acquire the spectrum provides the offer based on the first distribution attribute.

(5). The management electronic device according to (4), wherein the processing circuitry is configured to determine a selling price for the spectrum by one of:

if there are one or more spectrum acquisition electronic devices, among spectrum acquisition electronic devices to acquire the spectrum, whose offer is within the selling price interval, selecting a highest offer from offers of the one or more spectrum acquisition electronic devices, as the selling price of the spectrum;

if there is no spectrum acquisition electronic device, among spectrum acquisition electronic devices to acquire the spectrum, whose offer is within the selling price interval, selecting a lowest offer, from the offers of the spectrum acquisition electronic devices to acquire the spectrum, that is greater an upper limit of the selling price interval, as the selling price of the spectrum; and

if offers of the spectrum acquisition electronic devices to acquire the spectrum are all smaller than a lower limit of the selling price interval, selecting a highest offer from the offers of the spectrum acquisition electronic devices to acquire the spectrum, calculating an average of the selected highest offer and the lower limit of the selling price interval, and selecting one of the selected highest offer, the average, and the lower limit of the selling price interval as the selling price of the spectrum.

(6). The management electronic device according to any one of (1) to (5), wherein the processing circuitry is configured to determine, based on at least one of a first condition and a second condition, a set of spectrum providing electronic devices corresponding to the spectrum acquisition electronic device within the management range of the management electronic device,

wherein the first condition comprises that the spectrum acquisition electronic device and the spectrum providing electronic device involved in the trade of the spectrum are located in a same sector of the management electronic device, and the second condition comprises that the spectrum providing electronic device is located within a predetermined region centered on the spectrum acquisition electronic device.

(7). The management electronic device according to (6), wherein the processing circuitry is configured to calculate, in the case where the predetermined region is a circle, a first calculation radius corresponding to a case where the circle comprises a predetermined number of spectrum providing electronic devices, and a second calculation radius of an outer tangent circle of the spectrum acquisition electronic device to another co-frequency sector that is different from a sector in which the spectrum acquisition electronic device is located, wherein a radius of the circle is less than or equal to both the first calculation radius and the second calculation radius.

(8). The management electronic device according to any one of (1) to (7), wherein

the management electronic device is a subject in a spectrum management system configured as a blockchain architecture,

the spectrum management system comprises a plurality of subjects,

in addition to the management electronic device, the plurality of subjects comprises at least one of the spectrum acquisition electronic device, the spectrum providing electronic device, and other electronic device, and

the plurality of subjects respectively hold identical copies of a database, wherein the copies of the database respectively held by the plurality of subjects are updated based on information about spectrum trade which is verified as valid.

(9). The management electronic device according to (8), wherein

the other electronic device in the spectrum management system verifies validity of the spectrum trade in a case that the other electronic device is determined to be located within a validation region of the spectrum trade; and

a signal-to-noise ratio of the other electronic device is determined based on interference to the other electronic device when the spectrum acquisition electronic device in the spectrum trade utilizing the traded spectrum, and in a case where the signal-to-noise ratio is greater than a predetermined signal-to-noise ratio threshold set for the other electronic device, the other electronic device verifies that the spectrum trade is valid.

(10). The management electronic device according to (9), where the validation region is a circular region centered on the spectrum acquisition electronic device in the spectrum trade.

(11). A spectrum providing electronic device for wireless communication, including:

processing circuitry, where the processing circuitry is configured to:

determine, based on a first distribution attribute and a second distribution attribute determined by a management electronic device managing the spectrum providing electronic device, a selling price interval of a spectrum to be traded in spectrum trade related to the spectrum providing electronic device, for performing the spectrum trade,

wherein the first distribution attribute is a distribution attribute of spectrum acquisition electronic devices in a first region taking the management electronic device as a reference point, and the second distribution attribute is a distribution attribution of spectrum acquisition electronic devices in a second region taking the spectrum providing electronic device as a reference point.

(12). The spectrum providing electronic device according to (11), wherein

the first distribution attribute is characterized by a first heat vector, wherein the first heat vector indicates numbers of the spectrum acquisition electronic devices respectively included in a first plurality of concentric circles of which a center is the management electronic device, in the first region; and

the second distribution attribute is characterized by a second heat vector, wherein the second heat vector indicates numbers of the spectrum acquisition electronic devices respectively included in a second plurality of concentric circles of which a center is the spectrum providing electronic device, in the second region.

(13). The spectrum providing electronic device according to (12), wherein the processing circuitry is configured to:

in the case of determining that the spectrum providing electronic device is located between a first concentric circle having a first radius and a second concentric circle having a second radius greater than the first radius among the first plurality of concentric circles, calculate, based on the first radius and a first number of spectrum acquisition electronic devices corresponding to the first radius in the first heat vector, and the second radius and a second number of spectrum acquisition electronic devices corresponding to the second radius in the first heat vector, an anchor heat factor indicating a distribution density of spectrum acquisition electronic devices at a location within the first region where the spectrum providing electronic device is located;

calculate, based on the radius corresponding to each of the second plurality of concentric circles and the number of spectrum acquisition electronic devices corresponding to the radius included in the second heat vector, a current heat factor indicating a distribution density of the spectrum acquisition electronic devices at a location within the second region in which the spectrum providing electronic device is located; and

determine a selling price corresponding to the current heat factor based on a highest price and a lowest price in a predetermined price list and the anchor heat factor, and determine an interval in which the selling price falls within the range of the lowest price to the highest price is the selling price interval.

(14). The spectrum providing electronic device according to (13), wherein the processing circuitry is configured to:

calculate, for each of the first plurality of concentric circles, a distribution density of spectrum acquisition electronic devices corresponding to the concentric circle based on the radius corresponding to the concentric circle and the number of spectrum acquisition electronic devices corresponding to the radius in the first heat vector, and determine a highest distribution density among the calculated distribution densities as a highest heat factor; and

determine the selling price based on the highest heat factor.

(15). The spectrum providing electronic device according to (13) or (14), wherein the processing circuitry is configured to:

divide the number of spectrum acquisition electronic devices corresponding to each radius in the second heat vector by a square of the radius, to obtain a distribution density of spectrum acquisition electronic devices corresponding to each concentric circle, and calculate a weighted summation of the distribution density corresponding to each concentric circle, to calculate the current heat factor.

(16). The spectrum providing electronic device according to (15), wherein the processing circuitry is configured to:

assign a same weighting factor to the distribution density corresponding to each concentric circle, or

assign a weighting factor to the distribution density corresponding to each concentric circle based on the radius of the concentric circle.

(17). The spectrum providing electronic device according to (11), wherein

the first distribution attribute is characterized by a first quadrant vector, wherein the first quadrant vector indicates numbers of spectrum acquisition electronic devices respectively included in four quadrants of each of a third plurality of concentric circles of which a center is the management electronic device, in the first region; and

the second distribution attribute is characterized by a second quadrant vector, wherein the second quadrant vector indicates numbers of spectrum acquisition electronic devices respectively included in four quadrants of a circle of which a center is the spectrum providing electronic device, in the second region.

(18). The spectrum providing electronic device according to (17), wherein the processing circuitry is configured to:

in the case of determining that the spectrum providing electronic device is located between a third concentric circle having a third radius and a fourth concentric circle having a fourth radius greater than the third radius among the third plurality of concentric circles, calculate, based on the third radius and the number of spectrum acquisition electronic devices respectively included in four quadrants corresponding to the third radius in the first quadrant vector, an anchor quadrant factor indicating a distribution density of the spectrum acquisition electronic devices at a location within the first region in which the spectrum providing electronic device is located;

calculate, based on the radius of the circle and the numbers of spectrum acquisition electronic devices respectively included in the four quadrants in the second quadrant vector, a current quadrant factor indicating a distribution density of spectrum acquisition electronic devices at a location within the second region where the spectrum providing electronic device is located; and

determine a selling price corresponding to the current quadrant factor based on a maximum price and a minimum price in a predetermined price list and the anchor quadrant factor, and determine an interval in which the selling price falls within a range from the minimum price to the maximum price as the selling price interval.

(19). The spectrum providing electronic device according to (18), wherein the processing circuitry is configured to:

calculate, for each of the third plurality of concentric circles, a distribution density of spectrum acquisition electronic devices corresponding to each of the four quadrants of the concentric circle based on the radius corresponding to the concentric circle included in the first quadrant vector and the number of spectrum acquisition electronic devices in the quadrant corresponding to the radius in the first quadrant vector, and determine a highest distribution density of the calculated distribution densities as a highest quadrant factor; and

determine the selling price based on the highest quadrant factor.

(20). The spectrum providing electronic device according to (18) or (19), wherein the processing circuitry is configured to:

divide the number of spectrum acquisition electronic devices included in each of the four quadrants in the second quadrant vector by a square of the radius of the circle to obtain a distribution density of spectrum acquisition electronic devices corresponding to each quadrant, and calculate a weighted summation of the distribution density corresponding to each quadrant, to calculate the current quadrant factor.

(21). The spectrum providing electronic device according to any one of (11) to (20), wherein the spectrum providing electronic device is a subject in a spectrum management system configured as a blockchain architecture, and in addition to the spectrum providing electronic device, the spectrum management system comprises at least one of a management electronic device, a spectrum acquisition electronic device, and other electronic device.

(22). A spectrum acquisition electronic device for wireless communication, comprising:

processing circuitry, where the processing circuitry is configured to:

determine, based on distribution attributions of spectrum acquisition electronic devices in a region taking a management electronic device as a reference point, an offer for a spectrum to be traded in spectrum trade related to the spectrum acquisition electronic device, for performing the spectrum trade,

wherein the management electronic device is an electronic device which manages the spectrum acquisition electronic device.

(23). The spectrum acquisition electronic device according to (22), wherein the distribution attribute is characterized by a heat vector, and the heat vector indicates numbers of spectrum acquisition electronic devices respectively included in a first plurality of concentric circles of which a center is the management electronic device, in the region.

(24). The spectrum acquisition electronic device according to (23), wherein the processing circuitry is configured to:

if it is determined based on location information within the region of a spectrum providing electronic device of the spectrum to be traded that the spectrum providing electronic device is located between a first concentric circle having a first radius and a second concentric circle having a second radius greater than the first radius among the plurality of first concentric circles: estimate, based on the first radius and a first number of spectrum acquisition electronic devices corresponding to the first radius in the heat vector, and the second radius and a second number of spectrum acquisition electronic devices corresponding to the second radius in the heat vector, an anchor heat factor indicating a distribution density of spectrum acquisition electronic devices at a location in the region where the spectrum providing electronic device is located; and

estimate a price value corresponding to the anchor heat factor based on a highest price and a lowest price in the predetermined price list, and generate the offer based on the price value.

(25). The spectrum acquisition electronic device according to (24), wherein the processing circuitry is configured to:

calculate, for each of the first plurality of concentric circles, a distribution density of spectrum acquisition electronic devices corresponding to the concentric circle based on a radius corresponding to the concentric circle in the heat vector and the number of spectrum acquisition electronic devices corresponding to the radius, determine a highest distribution density among the calculated distribution densities as a highest heat factor and a lowest distribution density among the calculated distribution densities as a lowest heat factor; and

estimate the price value corresponding to the anchor heat factor based on the highest heat factor and the lowest heat factor.

(26). The spectrum acquisition electronic device according to (22), wherein the distribution attribute is characterized by a first quadrant vector, the first quadrant vector indicates numbers of spectrum acquisition electronic devices respectively included in the four quadrants of each of the third plurality of concentric circles of which a center is the management electronic device, in the region.

(27). The spectrum acquisition electronic device according to (26), wherein the processing circuitry is configured to determine the offer of the spectrum to be traded based on a second quadrant vector, wherein the second quadrant vector indicates numbers of spectrum acquisition electronic devices respectively included in the four quadrants of a circle of which a center is the spectrum providing electronic device of the spectrum to be traded.

(28). The spectrum acquisition electronic device according to (27), where the processing circuitry is configured to:

calculate, for each of the third plurality of concentric circles, a distribution density of the spectrum acquisition electronic devices corresponding to each quadrant of the concentric circle based on the radius of the concentric circle and the numbers of spectrum acquisition electronic devices included in each of the four quadrants corresponding to the radius in the first quadrant vector, and determine a highest distribution density among the calculated distribution densities as a highest quadrant factor and a lowest distribution density among the calculated distribution densities as a lowest quadrant factor;

estimate, based on the radius of the circle included in the second quadrant vector and the number of spectrum acquisition electronic devices included in each of the four quadrants, a current quadrant factor indicating a distribution density of spectrum acquisition electronic devices at a location within the circle where the spectrum providing electronic device is located; and

estimate a price value corresponding to the current quadrant factor based on a highest price and a lowest price in a predetermined price list, the highest quadrant factor and the lowest quadrant factor, and generate an offer based on the price value.

(29). The spectrum acquisition electronic device according to any one of (24), (25), and (28), wherein the processing circuitry is configured to:

randomly generate the offer based on a Gaussian distribution, wherein the price value serves as a mean of the Gaussian distribution; and

generate a variance of the Gaussian distribution based on the highest and lowest prices.

(30). The spectrum acquisition electronic device according to any one of (22) to (29), wherein

the spectrum acquisition electronic device is a subject in a spectrum management system configured as a blockchain architecture, and in addition to the spectrum acquisition electronic device, the spectrum management system comprises at least one of a management electronic device, a spectrum providing electronic device, and other electronic device.

(31). A method for wireless communication, including:

determining a first distribution attribute of spectrum acquisition electronic devices in a first region taking the management electronic device as a reference point, and for a spectrum to be traded in a management range of the management electronic device, determining a second distribution attribute of spectrum acquisition electronic devices in a second region taking a spectrum providing electronic device of the spectrum as a reference point, so as to manage trade of the spectrum based on the first distribution attribute and the second distribution attribute.

(32). A method for wireless communication, including:

determining, based on a first distribution attribute and a second distribution attribute determined by a management electronic device managing a spectrum providing electronic device, a selling price interval of a spectrum to be traded in spectrum trade related to the spectrum providing electronic device, for performing the spectrum trade,

wherein the first distribution attribute is a distribution attribute of spectrum acquisition electronic devices in a first region taking the management electronic device as a reference point, and the second distribution attribute is a distribution attribution of spectrum acquisition electronic devices in a second region taking the spectrum providing electronic device as a reference point.

(33). A method for wireless communication, including:

determining, based on distribution attributions of spectrum acquisition electronic devices in a region taking a management electronic device as a reference point, an offer for a spectrum to be traded in spectrum trade related to a spectrum acquisition electronic device, for performing the spectrum trade,

wherein the management electronic device is an electronic device which manages the spectrum acquisition electronic device.

(34). A computer readable storage medium storing computer executable instructions, where the computer executable instructions are executed to perform the method for wireless communication according to any one of (31) to (33).

1. A management electronic device for wireless communication, comprising:
processing circuitry, wherein the processing circuitry is configured to:
determine a first distribution attribute of spectrum acquisition electronic devices in a first region taking the management electronic device as a reference point, and for a spectrum to be traded in a management range of the management electronic device, determine a second distribution attribute of spectrum acquisition electronic devices in a second region taking a spectrum providing electronic device of the spectrum as a reference point, so as to manage trade of the spectrum based on the first distribution attribute and the second distribution attribute.

2. The management electronic device according to claim 1, wherein
the first distribution attribute is characterized by a first heat vector, wherein the first heat vector indicates numbers of the spectrum acquisition electronic devices respectively included in a first plurality of concentric circles of which a center is the management electronic device, in the first region; and
the second distribution attribute is characterized by a second heat vector, wherein the second heat vector indicates numbers of the spectrum acquisition electronic devices respectively included in a second plurality of concentric circles of which a center is the spectrum providing electronic device, in the second region, or
wherein
the first distribution attribute is characterized by a first quadrant vector, wherein the first quadrant vector indicates numbers of the spectrum acquisition electronic devices respectively included in four quadrants of each of a third plurality of concentric circles of which a center is the management electronic device, in the first region; and
the second distribution attribute is characterized by a second quadrant vector, wherein the second quadrant vector indicates numbers of the spectrum acquisition electronic devices respectively included in four quadrants of a circle of which a center is the spectrum providing electronic device, in the second region.

3. (canceled)

4. The management electronic device according to claim 1, wherein the processing circuitry is configured to:
match a selling price interval for the spectrum provided by the spectrum providing electronic device with an offer for the spectrum provided by the spectrum acquisition electronic device which is to acquire the spectrum, wherein
the spectrum providing electronic device provides the selling price interval based on the first distribution attribute and the second distribution attribute, and the spectrum acquisition electronic device which is to acquire the spectrum provides the offer based on the first distribution attribute.

5. The management electronic device according to claim 4, wherein the processing circuitry is configured to determine a selling price for the spectrum by one of:
if there are one or more spectrum acquisition electronic devices, among spectrum acquisition electronic devices to acquire the spectrum, whose offer is within the selling price interval, selecting a highest offer from offers of the one or more spectrum acquisition electronic devices, as the selling price of the spectrum;
if there is no spectrum acquisition electronic device, among spectrum acquisition electronic devices to acquire the spectrum, whose offer is within the selling price interval, selecting a lowest offer, from the offers of the spectrum acquisition electronic devices to acquire the spectrum, that is greater an upper limit of the selling price interval, as the selling price of the spectrum; and
if offers of the spectrum acquisition electronic devices to acquire the spectrum are all smaller than a lower limit of the selling price interval, selecting a highest offer from the offers of the spectrum acquisition electronic devices to acquire the spectrum, calculating an average of the selected highest offer and the lower limit of the selling price interval, and selecting one of the selected highest offer, the average, and the lower limit of the selling price interval as the selling price of the spectrum.

6. The management electronic device according to claim 1, wherein the processing circuitry is configured to determine, based on at least one of a first condition and a second condition, a set of spectrum providing electronic devices corresponding to the spectrum acquisition electronic device within the management range of the management electronic device,
wherein the first condition comprises that the spectrum acquisition electronic device and the spectrum providing electronic device involved in the trade of the spectrum are located in a same sector of the management electronic device, and the second condition comprises that the spectrum providing electronic device is located within a predetermined region centered on the spectrum acquisition electronic device.

7. The management electronic device according to claim 6, wherein the processing circuitry is configured to calculate, in the case where the predetermined region is a circle, a first calculation radius corresponding to a case where the circle comprises a predetermined number of spectrum providing electronic devices, and a second calculation radius of an outer tangent circle of the spectrum acquisition electronic device to another co-frequency sector that is different from a sector in which the spectrum acquisition electronic device is located, wherein a radius of the circle is less than or equal to both the first calculation radius and the second calculation radius.

8.-10. (canceled)

11. A spectrum providing electronic device for wireless communication, comprising:
processing circuitry, wherein the processing circuitry is configured to:
determine, based on a first distribution attribute and a second distribution attribute determined by a management electronic device managing the spectrum providing electronic device, a selling price interval of a spectrum to be traded in spectrum trade related to the spectrum providing electronic device, for performing the spectrum trade,
wherein the first distribution attribute is a distribution attribute of spectrum acquisition electronic devices in a first region taking the management electronic device as a reference point, and the second distribution attribute is a distribution attribution of spectrum acquisition electronic devices in a second region taking the spectrum providing electronic device as a reference point.

12. The spectrum providing electronic device according to claim 11, wherein
the first distribution attribute is characterized by a first heat vector, wherein the first heat vector indicates numbers of the spectrum acquisition electronic devices respectively included in a first plurality of concentric circles of which a center is the management electronic device, in the first region; and
the second distribution attribute is characterized by a second heat vector, wherein the second heat vector indicates numbers of the spectrum acquisition electronic devices respectively included in a second plurality of concentric circles of which a center is the spectrum providing electronic device, in the second region.

13. The spectrum providing electronic device according to claim 12, wherein the processing circuitry is configured to:
in the case of determining that the spectrum providing electronic device is located between a first concentric circle having a first radius and a second concentric circle having a second radius greater than the first radius among the first plurality of concentric circles, calculate, based on the first radius and a first number of spectrum acquisition electronic devices corresponding to the first radius in the first heat vector, and the second radius and a second number of spectrum acquisition electronic devices corresponding to the second radius in the first heat vector, an anchor heat factor indicating a distribution density of spectrum acquisition electronic devices at a location within the first region where the spectrum providing electronic device is located;
calculate, based on the radius corresponding to each of the second plurality of concentric circles and the number of spectrum acquisition electronic devices corresponding to the radius included in the second heat vector, a current heat factor indicating a distribution density of the spectrum acquisition electronic devices at a location within the second region in which the spectrum providing electronic device is located; and
determine a selling price corresponding to the current heat factor based on a highest price and a lowest price in a predetermined price list and the anchor heat factor, and determine an interval in which the selling price falls within the range of the lowest price to the highest price is the selling price interval.

14. The spectrum providing electronic device according to claim 13, wherein the processing circuitry is configured to:
calculate, for each of the first plurality of concentric circles, a distribution density of spectrum acquisition electronic devices corresponding to the concentric circle based on the radius corresponding to the concentric circle and the number of spectrum acquisition electronic devices corresponding to the radius in the first heat vector, and determine a highest distribution density among the calculated distribution densities as a highest heat factor; and
determine the selling price based on the highest heat factor.

15. The spectrum providing electronic device according to claim 13, wherein the processing circuitry is configured to:
divide the number of spectrum acquisition electronic devices corresponding to each radius in the second heat vector by a square of the radius, to obtain a distribution density of spectrum acquisition electronic devices corresponding to each concentric circle, and calculate a weighted summation of the distribution density corresponding to each concentric circle, to calculate the current heat factor.

16. (canceled)

17. The spectrum providing electronic device according to claim 11, wherein
the first distribution attribute is characterized by a first quadrant vector, wherein the first quadrant vector indicates numbers of spectrum acquisition electronic devices respectively included in four quadrants of each of a third plurality of concentric circles of which a center is the management electronic device, in the first region; and
the second distribution attribute is characterized by a second quadrant vector, wherein the second quadrant vector indicates numbers of spectrum acquisition electronic devices respectively included in four quadrants of a circle of which a center is the spectrum providing electronic device, in the second region.

18. The spectrum providing electronic device according to claim 17, wherein the processing circuitry is configured to:
in the case of determining that the spectrum providing electronic device is located between a third concentric circle having a third radius and a fourth concentric circle having a fourth radius greater than the third radius among the third plurality of concentric circles, calculate, based on the third radius and the number of spectrum acquisition electronic devices respectively included in four quadrants corresponding to the third radius in the first quadrant vector, an anchor quadrant factor indicating a distribution density of the spectrum acquisition electronic devices at a location within the first region in which the spectrum providing electronic device is located;
calculate, based on the radius of the circle and the numbers of spectrum acquisition electronic devices respectively included in the four quadrants in the second quadrant vector, a current quadrant factor indicating a distribution density of spectrum acquisition electronic devices at a location within the second region where the spectrum providing electronic device is located; and
determine a selling price corresponding to the current quadrant factor based on a maximum price and a minimum price in a predetermined price list and the anchor quadrant factor, and determine an interval in which the selling price falls within a range from the minimum price to the maximum price as the selling price interval.

19. The spectrum providing electronic device according to claim 18, wherein the processing circuitry is configured to:
calculate, for each of the third plurality of concentric circles, a distribution density of spectrum acquisition electronic devices corresponding to each of the four quadrants of the concentric circle based on the radius corresponding to the concentric circle included in the first quadrant vector and the number of spectrum acquisition electronic devices in the quadrant corresponding to the radius in the first quadrant vector, and determine a highest distribution density of the calculated distribution densities as a highest quadrant factor; and
determine the selling price based on the highest quadrant factor, or
wherein the processing circuitry is configured to:
divide the number of spectrum acquisition electronic devices included in each of the four quadrants in the second quadrant vector by a square of the radius of the circle to obtain a distribution density of spectrum acquisition electronic devices corresponding to each quadrant, and calculate a weighted summation of the distribution density corresponding to each quadrant, to calculate the current quadrant factor.

20.-21. (canceled)

22. A spectrum acquisition electronic device for wireless communication, comprising:
processing circuitry, wherein the processing circuitry is configured to:
determine, based on distribution attributions of spectrum acquisition electronic devices in a region taking a management electronic device as a reference point, an offer for a spectrum to be traded in spectrum trade related to the spectrum acquisition electronic device, for performing the spectrum trade,
wherein the management electronic device is an electronic device which manages the spectrum acquisition electronic device.

23. The spectrum acquisition electronic device according to claim 22, wherein the distribution attribute is characterized by a heat vector, and the heat vector indicates numbers of spectrum acquisition electronic devices respectively included in a first plurality of concentric circles of which a center is the management electronic device, in the region.

24. The spectrum acquisition electronic device according to claim 23, wherein the processing circuitry is configured to:
if it is determined based on location information within the region of a spectrum providing electronic device of the spectrum to be traded that the spectrum providing electronic device is located between a first concentric circle having a first radius and a second concentric circle having a second radius greater than the first radius among the plurality of first concentric circles: estimate, based on the first radius and a first number of spectrum acquisition electronic devices corresponding to the first radius in the heat vector, and the second radius and a second number of spectrum acquisition electronic devices corresponding to the second radius in the heat vector, an anchor heat factor indicating a distribution density of spectrum acquisition electronic devices at a location in the region where the spectrum providing electronic device is located; and
estimate a price value corresponding to the anchor heat factor based on a highest price and a lowest price in the predetermined price list, and generate the offer based on the price value.

25. The spectrum acquisition electronic device according to claim 24, wherein the processing circuitry is configured to:
calculate, for each of the first plurality of concentric circles, a distribution density of spectrum acquisition electronic devices corresponding to the concentric circle based on a radius corresponding to the concentric circle in the heat vector and the number of spectrum acquisition electronic devices corresponding to the radius, determine a highest distribution density among the calculated distribution densities as a highest heat factor and a lowest distribution density among the calculated distribution densities as a lowest heat factor; and
estimate the price value corresponding to the anchor heat factor based on the highest heat factor and the lowest heat factor.

26. The spectrum acquisition electronic device according to claim 22, wherein the distribution attribute is characterized by a first quadrant vector, the first quadrant vector indicates numbers of spectrum acquisition electronic devices respectively included in the four quadrants of each of the third plurality of concentric circles of which a center is the management electronic device, in the region.

27. The spectrum acquisition electronic device according to claim 26, wherein the processing circuitry is configured to determine the offer of the spectrum to be traded based on a second quadrant vector, wherein the second quadrant vector indicates numbers of spectrum acquisition electronic devices respectively included in the four quadrants of a circle of which a center is the spectrum providing electronic device of the spectrum to be traded.

28.-34. (canceled)
